(19) United States
(12) Patent Application Publication
(10) Pub. No.: US 2013/0179354 A1
(43) Pub. Date: Jul. 11, 2013

(54) Automated System for Commissioning Verification, Progress Tracking and Punchlist Resolution of Oil and Gas Production Facilities

(71) Applicant: Steven Gary Seat, Houston, TX (US)

(72) Inventor: Steven Gary Seat, Houston, TX (US)

(21) Appl. No.: 13/710,633

(22) Filed: Dec. 11, 2012

Related U.S. Application Data
(60) Provisional application No. 61/570,083, filed on Dec. 13, 2011.

(51) Int. Cl. G06Q 10/10

(52) U.S. Cl. CPC G06Q 10/103
USPC 705/301

(57) ABSTRACT

Automated System for Commissioning Verification, Progress Tracking and Punchlist Resolution of Oil and Gas Production Facilities is disclosed. This invention eliminates the need for manual generation of hardcopy inspection reports and engineering documents by providing field inspectors mobile devices for real-time access to the document control system. The invention also provides immediate notification to all Users when a revised document has been uploaded into the document control system. The invention provides automated and real-time progress updates, and eliminates delays from manually coding and scanning documents. Punchlist deficiencies and corresponding digital images are entered in the field for immediate viewing by onsite and offsite management, engineers and vendors via internet access, allowing for immediate direction or approvals. Material procurement requirements are entered in the field for immediate viewing and action by procurement personnel. The invention will result in a significant reduction in commissioning project duration and commissioning man-hours expended.

### BACKGROUND OF THE INVENTION

The commissioning of onshore and offshore oil and gas production facilities is the final construction activity performed in preparation for the facility start-up. It is essential that the commissioning activities are carried out in a manner that verifies all piping, mechanical equipment, instrumentation and electrical devices are tested to ensure installation is correct and the equipment and devices are safe to operate. The verification of the tests by the commissioning team and the subsequent Client approval of the tests currently involve the completion of thousands of hardcopy inspection reports and scanning the documents into a database for document storage. The database stores the inspection documents in folders for each production system and progress is reported for each production system based on the percentage of approved documents scanned and stored.

Thousands of man-hours are spent by commissioning team members preparing the initial hardcopies of vendor documents and engineering data, inspection reports, field measured data, and Client approval certificates for each of the hundreds of binders of System Completion Packages (SCP's) prepared for a typical project. A separate SCP binder will be prepared for each major piece of equipment in the facility. Each SCP typically represents a Sub-system for the multiple Production and Utility Systems. The typical commissioning project scope of work, for both onshore and offshore projects, can have up to 100 Production and Utility Systems and up to 1000 Sub-systems. Commissioning team members then make copies of the necessary documents to carry to the fabrication site to record their inspections and field measurements. This often results in return trips to the office for forgotten documents and multiple trips to the field for repeat inspections and to obtain approvals by Client and fabrication contractor personnel.

Current commissioning systems are not capable of tracking the real-time progress of activities, nor do they capture or report real-time listings and status of Punchlist deficiencies or material purchase requirements identified in the Punchlist deficiencies. For commissioning systems currently on the market, these deficiencies and material purchase requirements are manually typed onto spreadsheet reports and manually updated for action and tracking by others. These existing commissioning systems result in time consuming multiple handling of all documents by inspectors, document control personnel and approvers and do not provide real-time tracking of progress, Punchlist deficiencies and procurement activities.

Existing commissioning systems require thousands of man-hours to re-write and type the field notes on inspection reports for document control personnel to then assign barcodes and scan the reports into the document control system.

### SUMMARY OF THE INVENTION

This invention automates the entire commissioning process including the creation and management of the document control system, the creation of the individual inspection Check Sheets, the creation of Completion Certificates and the Client approvals utilizing electronic signatures. The invention eliminates the need for the manual generation of hardcopy inspection reports and engineering support documents and provides field inspectors mobile devices for real-time access to the project document control system. The invention also provides immediate notification to all Users, including inspectors in the field, when a revised document has been uploaded into the document control system to ensure all team members are working with the most current documents and drawings. The invention provides automated and real-time progress updates with each inspection entry in the field, eliminating the delays from the manual coding and scanning of documents. Punchlist deficiencies and corresponding digital images are entered in the field for immediate viewing and direction by onsite and offsite management, engineers and vendors via Internet access. This allows for immediate direction, troubleshooting or approvals. Material procurement requirements are entered in the field for immediate viewing and action by procurement personnel, onsite or offsite. The invention will result in a significant reduction in the project duration and man-hours required to complete the commissioning activities. The invention is currently being marketed under the name EPICom.

### BRIEF DESCRIPTION OF THE DRAWINGS

FIG. 1 depicts the relationship between the invention's seven (7) claimed elements in [0027] and how they are controlled by the automated workflow, task management and document management System Software.

FIGS. 2-5 refers to Element 1 (claim 1) and depicts how the Software automatically generates each System Completion Package (SCP) document file structure for each of the Commissioning projects' construction Locations, the Components being constructed at each Location, the Process Systems within each Component, and Process Sub-system for each piece of equipment within each Process System.

FIGS. 6-14 refers to Element 2 (claim 2) and depicts how the Software allows all field Users access to view documents in the document control system, as well as in a separate module that only allows pre-approved Users the ability to input field data in the Check Sheet inspection reports, record field measured data and QAQC inspections, record Punchlist deficiencies, record material procurement requirements, input comments, attach third party field reports and obtain Contractor and Client approvals in the field using electronic signature boxes. The invention prohibits inadvertent or preliminary approvals by disabling the electronic signature feature until all QAQC checks are complete on the Check Sheet and all Critical “A” Punchlist items are complete.

FIGS. 15-17 refers to Element 3 (claim 3) and depicts how the Software automatically calculates progress for each Sub-system, System, Component, Location, and overall Project progress based on the real-time status of each individual Check Sheet. The automatically generated Progress Reports are accessible by all Users.

FIGS. 18-25 refers to Element 4 (claim 4) and depicts how the Software allows site office Users, field and offsite Users automated and real-time notification of revised documents received and downloaded into the document control system.

FIGS. 26-28 refers to Element 5 (claim 5) and depicts how the Software prevents premature approval of inspection reports that contain Critical Punchlist deficiencies. All Punchlist deficiencies are entered into the automated Punchlist pop-up box and must be defined as Critical or Non-critical by the inspector. Critical Punchlist items must be completed and approved by the Client prior to the software allowing final signatures and approvals of the Check Sheets.

FIG. 29 refers to Element 6 (claim 6) and depicts how the Software will automatically carry-over the list of incomplete Non-critical Punchlist deficiencies to the next corresponding inspection report and Completion Certificate as the work progresses from Mechanical Completion, to Pre-Commissioning and finally to Commissioning activities.

FIGS. 30-31 refers to Element 7 (claim 7) and depicts how the Software automatically generates a Completion Certificate for each of the project fabrication Locations, constructed Components, and the various production and utility systems within each Component for the Mechanical Completion, Pre-Commissioning and Commissioning phases of work associated with the project. The Completion Certificates will be generated and auto-populate the Certificate form with document numbers of each inspection report utilized within a Sub-system and lists all remaining Non-critical Punchlist deficiencies to be carried over to the next certification phase of the project. The invention prohibits the generation or approval of Completion Certificates if any inspection report is incomplete or not approved.

### DETAILED DESCRIPTION OF THE INVENTION

The invented software is a tool that will be utilized by Commissioning team members for onshore and offshore projects in the Oil & Gas industry. The Commissioning team will typically initiate the commissioning phase of an Oil & Gas project by setting up the document control system and separating the entire project scope of work into various Systems for all major process or production components (e.g., Oil Separation, Gas Compression, Pipeline pumps, etc.), and into Systems for all major utility components (e.g., Power Generation, Water Treating, Instrument Air, Firewater, etc.). After identifying all major Systems, the Systems will be sub-divided into Sub-Systems for each of the equipment components within that System. A typical project can have a total of 100 Systems and up to 1000 Sub-Systems. Because of the vast amount of documents required to execute the commissioning scope of work, generating hundreds of thousands of paper documents is not uncommon, a significant number of man-hours are expended handling the documents in paper format. The invented software allows the Commissioning team the ability to initiate and execute the project in a paperless format without the need for any paper documents to carry to the work site for recording the inspections and the field measurements and the subsequent scanning and filing of those documents.

After separating the project scope of work into the various Systems and Sub-Systems, the invented software is used to automatically generate the document control folder structure for each of the Sub-Systems System Completion Packages (SCP's). The software allows the User to simply input the Equipment descriptions and identification numbers (tag numbers) for each of the constructed components at each of the fabrication locations included in the scope of work (see claim Element 1).

Upon completing the automatic generation of the document control system, the field execution phase of the project can begin. The invented software automatically monitors and reports progress in real-time (see claim Element 3), allows field input, categorizing and tracking of Punchlist deficiencies with recorded digital images, and manages material procurement requirements (see claim Element 2). Field technicians performing commissioning checks and measurements will utilize a mobile device with keyboard and/or a stylus capability that is in continuous Wi-Fi communication with a host computer containing the invented software (see claim Element 2). The results of field inspections and the gathering of field measured data will be immediate and will not require the re-writing of Check Sheets and Punchlist items (see claim Element 2). All information can be viewed and used immediately by multiple parties including management, contractors, vendors and procurement personnel (see claim Element 2). The direct communication to the system database and documents in the document control system prevents multiple inspection trips to the field with hardcopy information. The real-time incorporation of all data and the easily accessible viewing of the data minimize the need for multiple trips to the field by Client approvers and allows for review and approval of deficiencies from their offsite offices by viewing the field measurements and digital images of before and after conditions. In summary, the invention significantly reduces the man-hours involved in commissioning of oil and gas production facilities by simplifying the inspection, data recording and approval process, as well as providing real-time status reports for progress, deficiencies and procurement.

Upon completion of the inspection activities for each of the Check Sheets within a Sub-System for each discipline (Piping, Mechanical, Electrical and Instrumentation), the invented software allows the User in the field to automatically generate a Completion Certificate appropriate for that scope of work. The automatically generated Completion Certificate lists each Check Sheet appropriate for that scope of work as well as any incomplete Non-Critical deficiencies that will be carried over to the next corresponding Completion Certificate (see claim Element 7).

The invention differs from what currently exists. Current commissioning systems are essentially a barcoded document control system to simplify the filing of thousands of documents into appropriate files and folders. This invention automates the field recording of inspections data gathering, Punchlist deficiencies and material procurement requirements directly in the field and provides real-time updating of progress and reports.

This invention is an improvement on what currently exists. The current commissioning systems are inefficient due to the manual preparation of hardcopy documents of inspection reports, incorporation of engineering data and vendor data, and requires the manual coding and scanning of documents and inspection reports (see claim Element 1). Current commissioning systems do not allow for immediate notification of revised engineering documents to the end Users in the field since they are working with hardcopies (see claim Element 4). In current commissioning systems, the tracking of project progress and the status of Punchlist deficiencies and material procurement is inefficient and error prone due to the multiple personnel required transferring handwritten notes to spreadsheets for sorting and monitoring (see claim Element 2). The ultimate Client approval of inspection reports is dependent on the timely resolution of recorded deficiencies and material procurement. Punchlist deficiencies are categorized as Critical (essential to equipment performance or safety and must be completed prior to Check Sheet approval), and Non-Critical (those not critical to the performance of the equipment and can be completed later). Because of the thousands of deficiencies recorded and the thousands of Check Sheet inspections to record the deficiencies, it is difficult to maintain control over deficiency status and Check Sheet completion. The invented software prevents the approval of any Check Sheet that contains un-approved Critical deficiencies (see claim Element 5). Current commissioning systems require numerous meetings of multiple parties to coordinate final inspections of the critical deficiencies, and non-critical deficiencies, and to ensure that Client approval is ultimately obtained. The invented software ensures that incomplete Non-Critical deficiencies are automatically transferred to the next corresponding Completion Certificate ensuring the deficiency continues to be tracked and not lost in the “paper work” of existing commissioning systems (see claim Element 6). The invented software also automatically generates Completion Certificates for field approval by Client representatives (see claim Element 7), eliminating the need to rewrite the paper copies of inspection reports and prepare a paper copy of a Completion Certificate for the commissioning team member to take back to the Client representative for signature.

This invention eliminates the need for the manual generation of hardcopy inspection reports and engineering support documents by providing field inspectors mobile devices for real-time access to the project document control system (see claim Element 1). The invention also provides immediate notification to all Users, including inspectors in the field, when a revised document has been uploaded into the document control system (see claim Element 4). The invention provides automated and real-time progress updates with each inspection entry in the field, eliminating the delays from the manual coding and scanning of documents (see claim Element 2). Punchlist deficiencies and corresponding digital images are entered in the field for immediate viewing and direction by onsite and offsite management, engineers and vendors via internet access. This allows for immediate direction, troubleshooting or approvals. Material procurement requirements are entered in the field for immediate viewing and action by procurement personnel, onsite or offsite. This invention will result in a significant reduction in the project duration and man-hours required to complete the commissioning activities.

The invention works utilizing the following document flow, commissioning execution and completion certification processes. The software is written using .net and C# programming languages and utilizes the Microsoft Sequel Server as the database platform.

Document Row Process:

1. Select project document (engineering or vendor data) to upload into the system.
Ex: SAFECHART_{—}2_Rev 1.pdf

2. Select the appropriate folder to store the document

3. Ensure document file name contains the document name and revision number which the software will use to determine when new revisions of a document are uploaded in the future.
Document Name: SAFECHART_{—}002_Rev 1
Destination Folder: Safechart
Document Number: 002
Revision Number: 1 (any numerical text after the 2nd underscore or dash symbol in the document name)

4. Software checks the database to see if the document name exists in any folder with a previous Revision number.

5. If it doesn't exist, THEN the software performs the following:
a. Copies physical file onto file server in selected folder
b. Inserts a row in the database table with all file information including revision number, destination folder, document number and physical path of the document
Otherwise, If the document does exist in the database with a previous revision number, THEN the software:
a. Copies the physical file onto the file server in the selected folder
b. Gets the first version of the document number of the document from the database
c. Inserts a row in the database table with all file information with revision number, destination folder, document number and physical path of the document along with all other revisions with the same document number, so that all revisions with the same document numbers are linked.
d. Verify if the previous version of the document is allotted to a SCP folder in the database
e. If YES, update SCP record with ReviewPending Flag as TRUE so system can display red flag in front of the document in the document folder inside the Sub-System.

7. Displays the latest Revision number. User to verify and REPLACE documents indicated with red flags in document folders and SCP folders.
Red Flag remains in place until the latest Revision of the document replaces the previous Revision.

Commissioning Execution-Check Sheet and Punchlist Entry and Sign-off:

1. The SIGNATURES tab will be inactivated until the following steps are completed,
a. All the Check Sheet inspection checklist items should be closed (listed as either OK or NA).
b. All Critical Punchlist items must be closed prior to approval

2. The Punchlist deficiency items are created for the Check Sheet inspection checklist items, or can be entered independently from the inspection items.

3. There are two types of Punchlist deficiency items depending on the criticality.
a. “A” Critical—Must be completed prior to approving and signing Check Sheet
b. “B” Non-Critical—Not required to be closed prior to signing Check Sheet

4. All Critical Punchlist items should be completed before signing off the Check Sheet.

5. If the “B” Punchlist items are still opened while signing off the Check

Sheet, then all open “B” Punchlist items will be recorded on the Mechanical Completion, Pre-Commissioning, or Commissioning Check Sheet(s) automatically.

6. The detailed status of the Punchlist items can be viewed in both the current Check Sheet tab and in the Punchlist tab.

Completion Certification Process:

1. All the completion certification report folders will be automatically created as part of the SCP document control folder structure

2. The list of inspection report EPICom document numbers and non-critical

Punchlist items carried over to the next commissioning phase will be automatically displayed on the completion certification screens.

3. The signing section of the certification will be activated only when all inspection reports are completed and signed off.

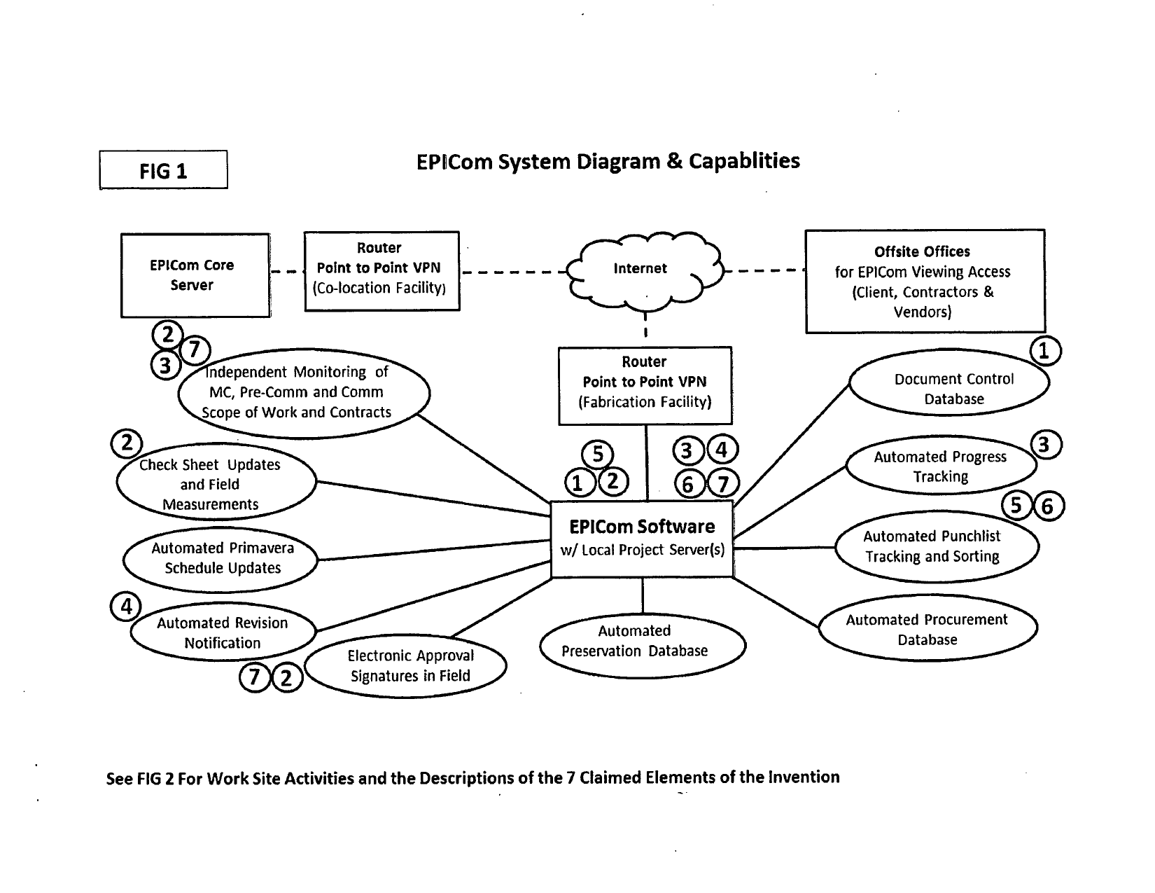

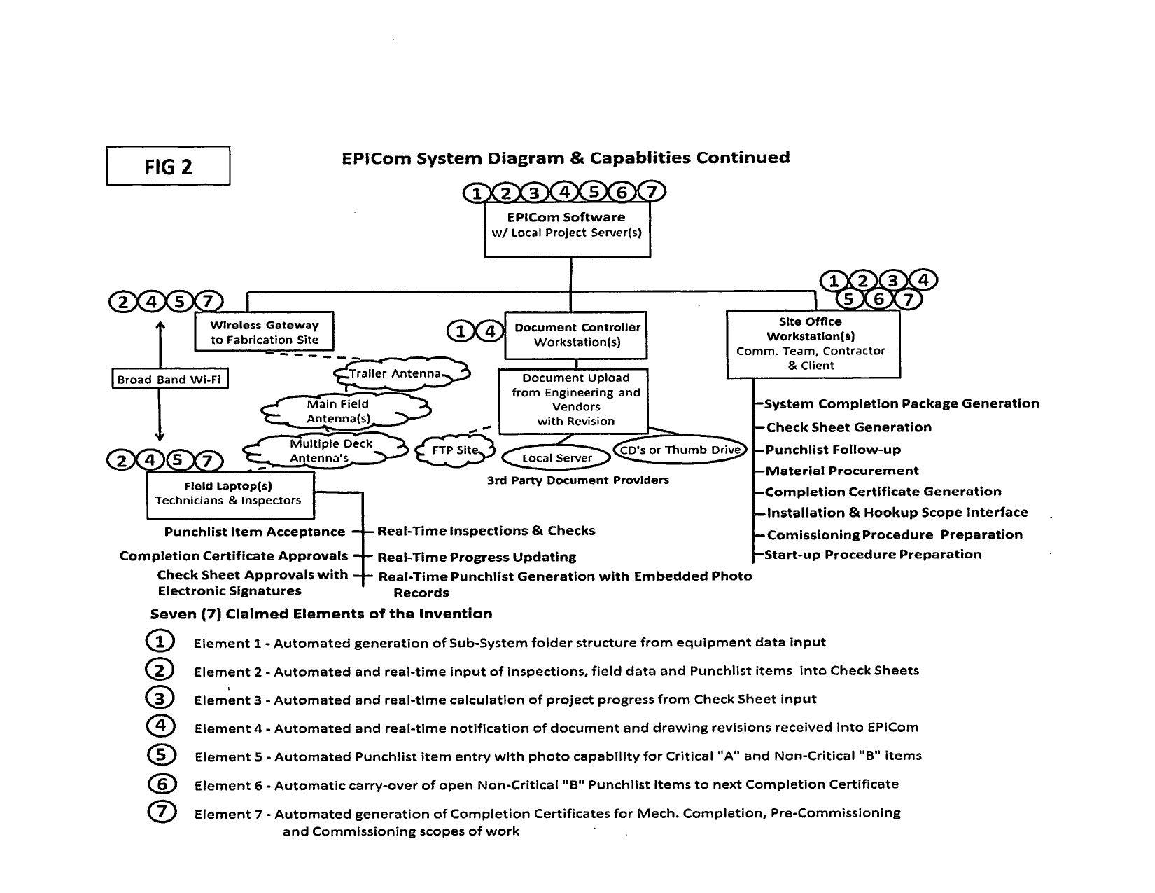

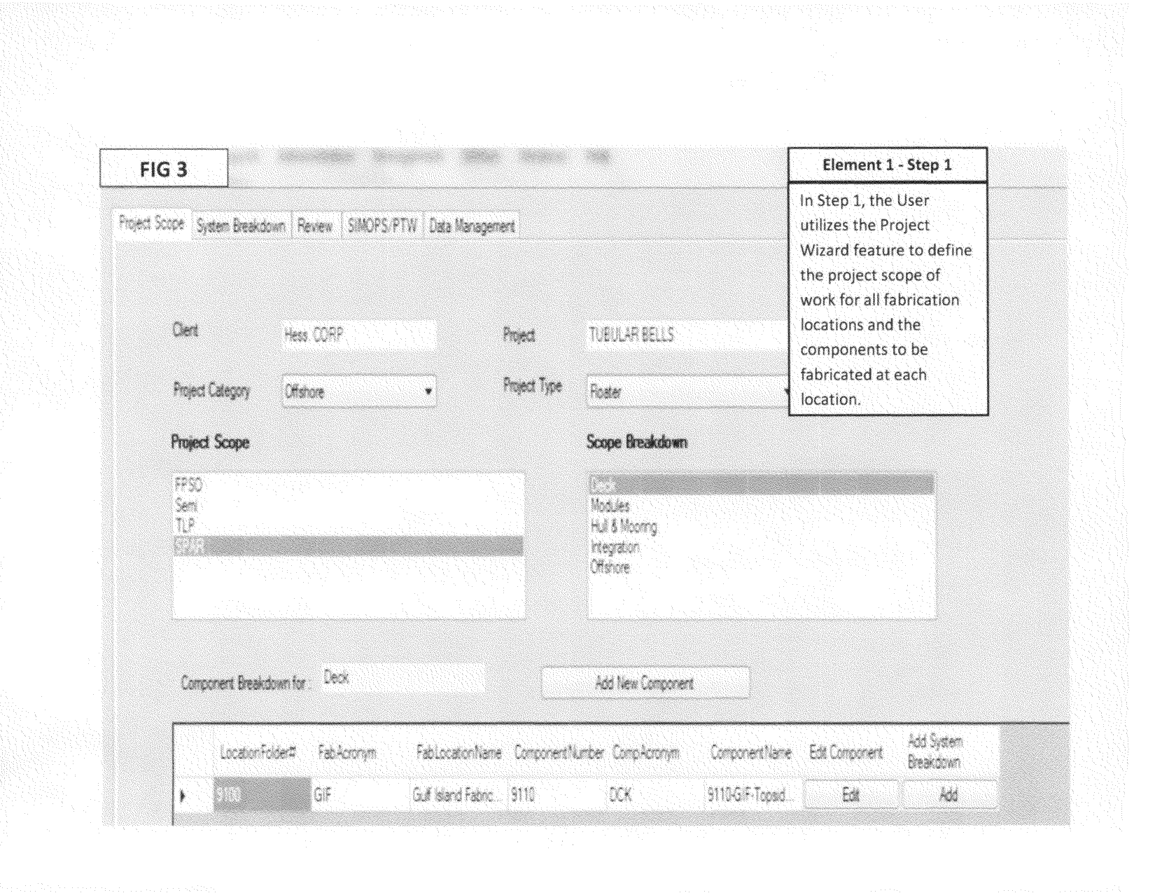

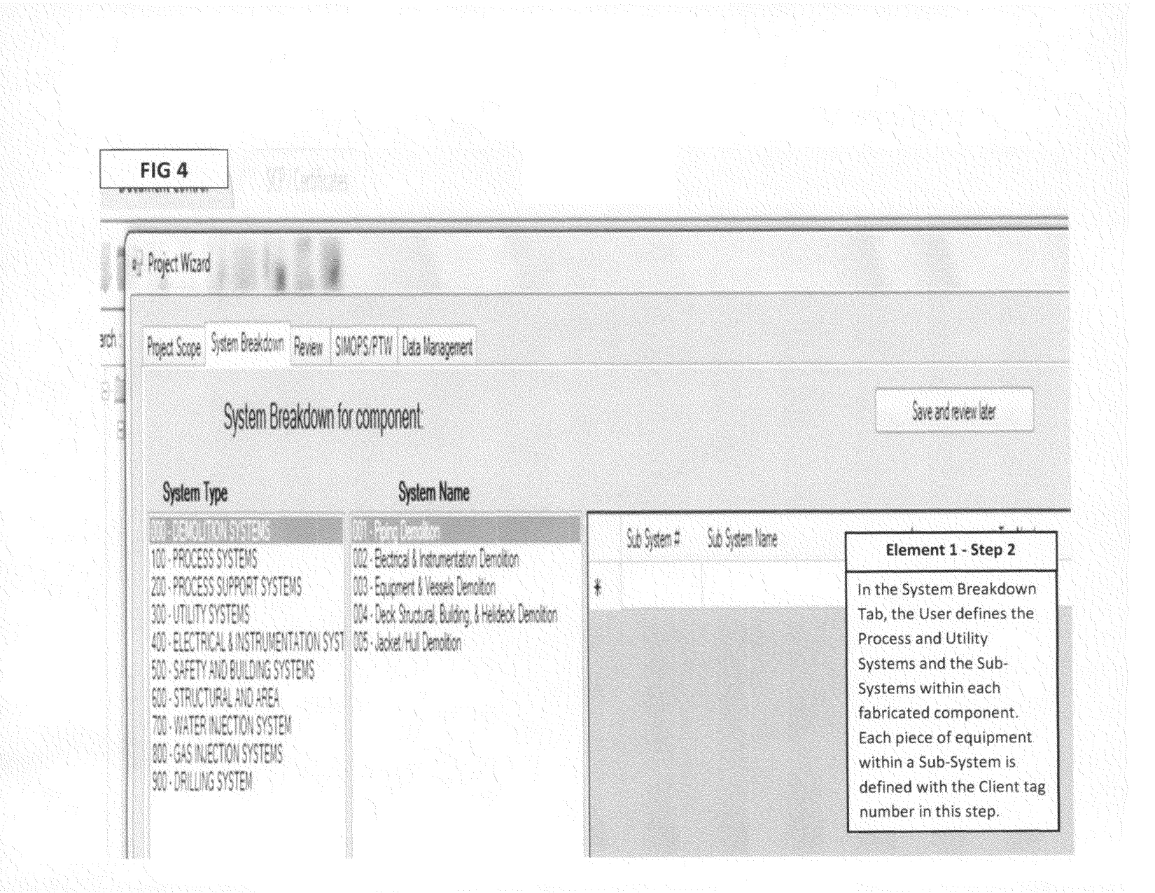

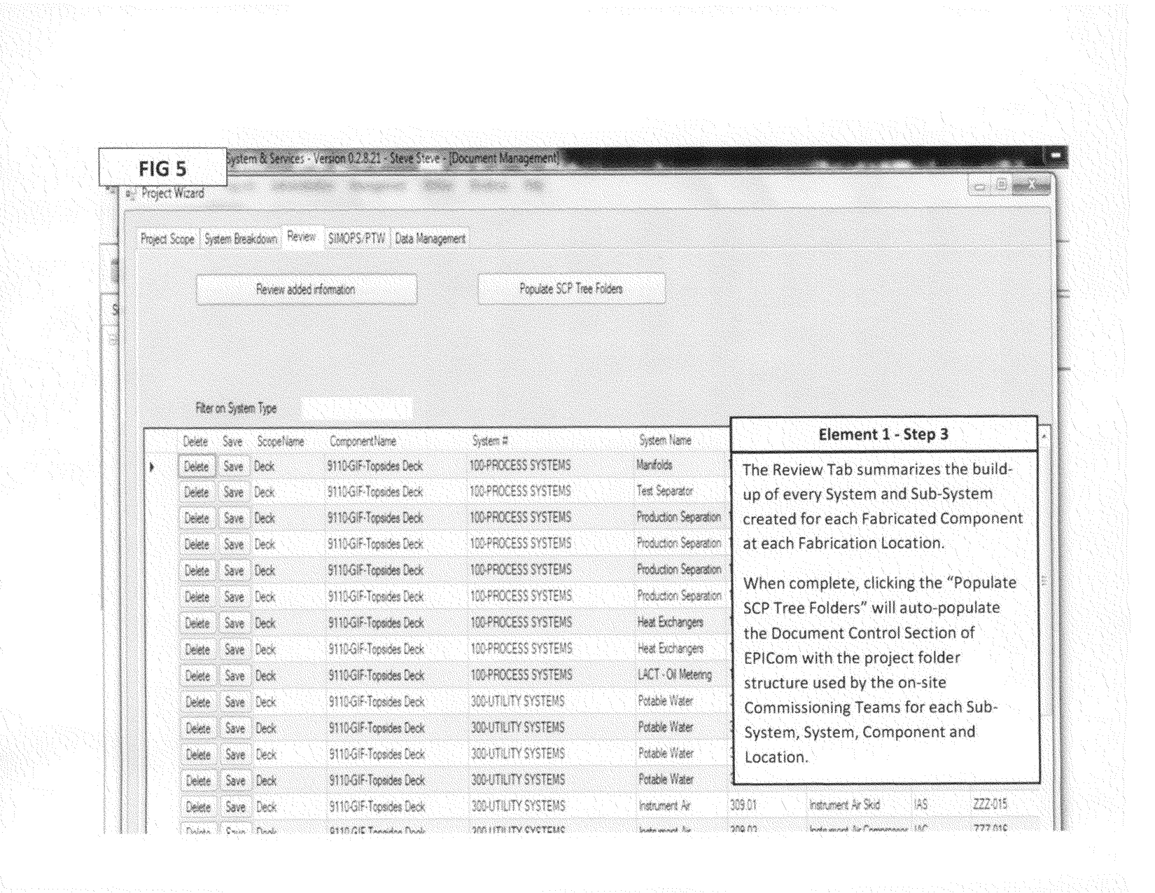

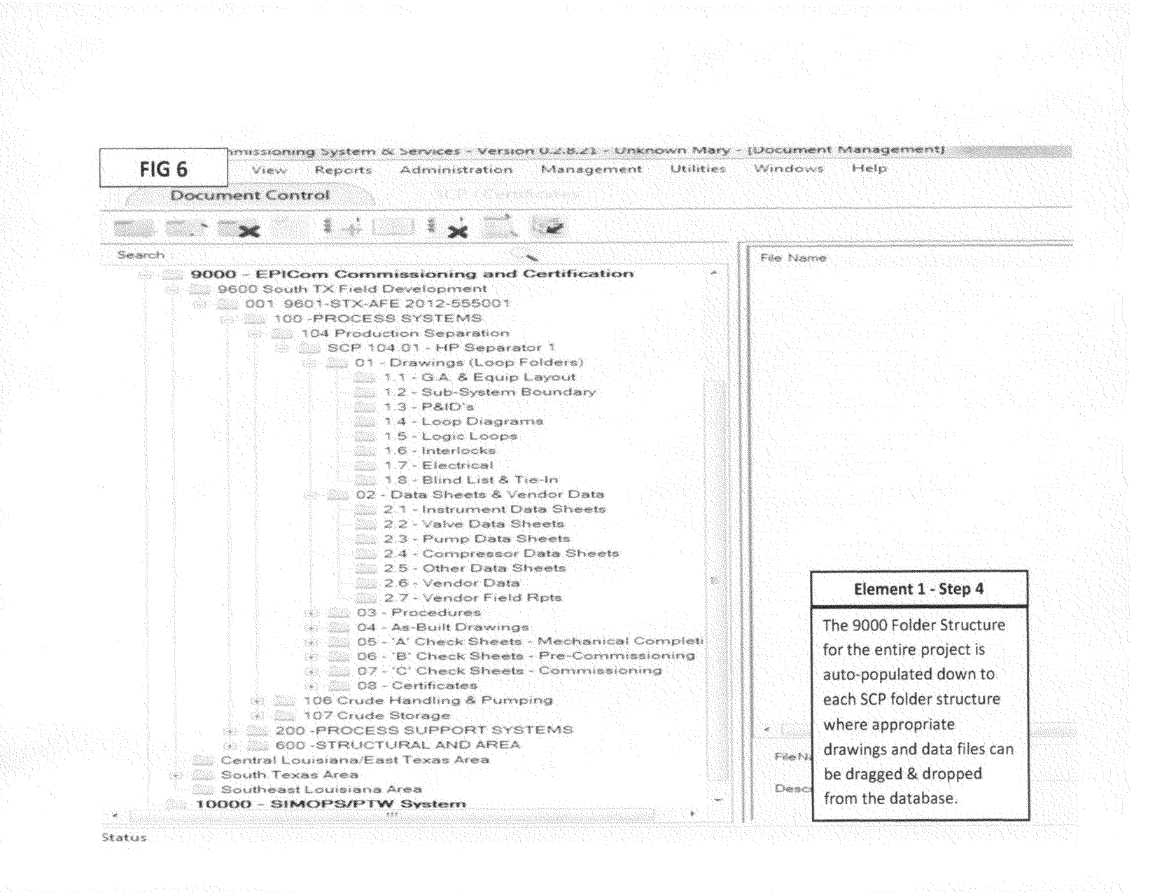

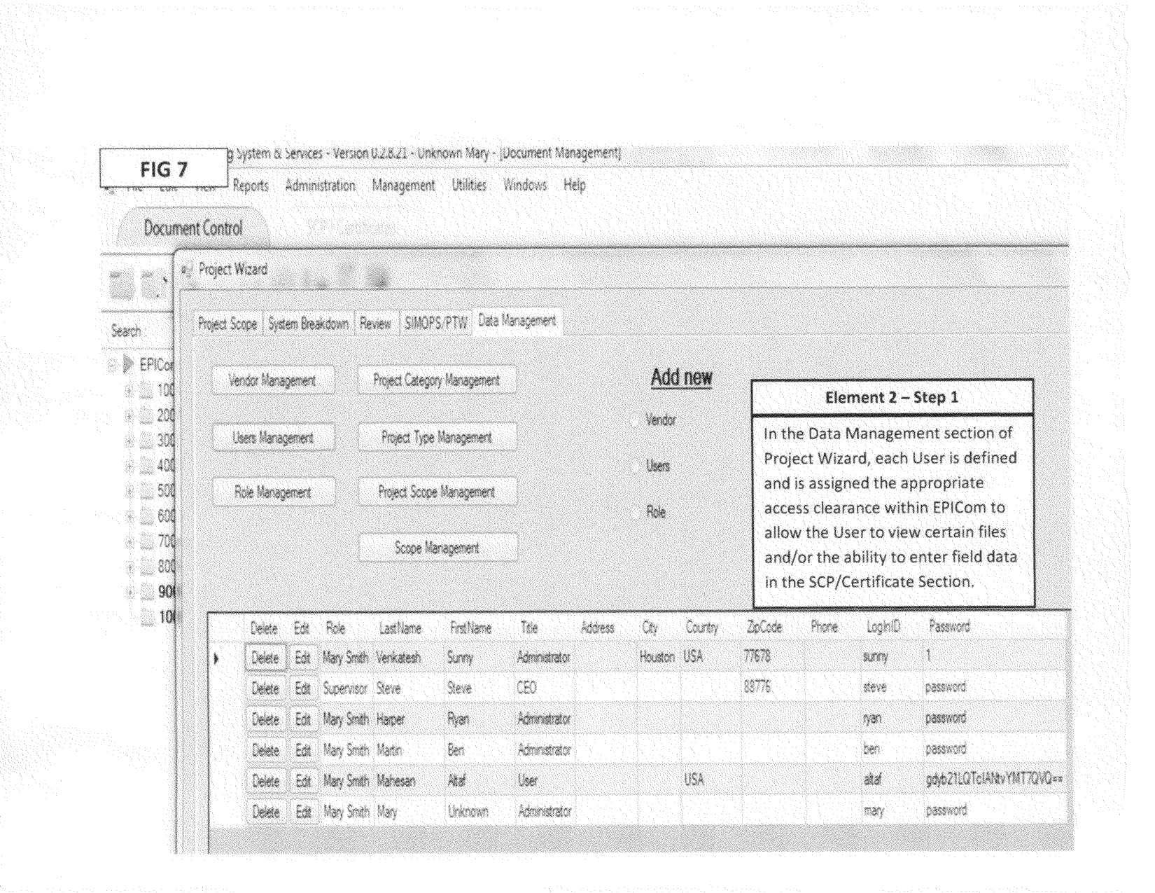

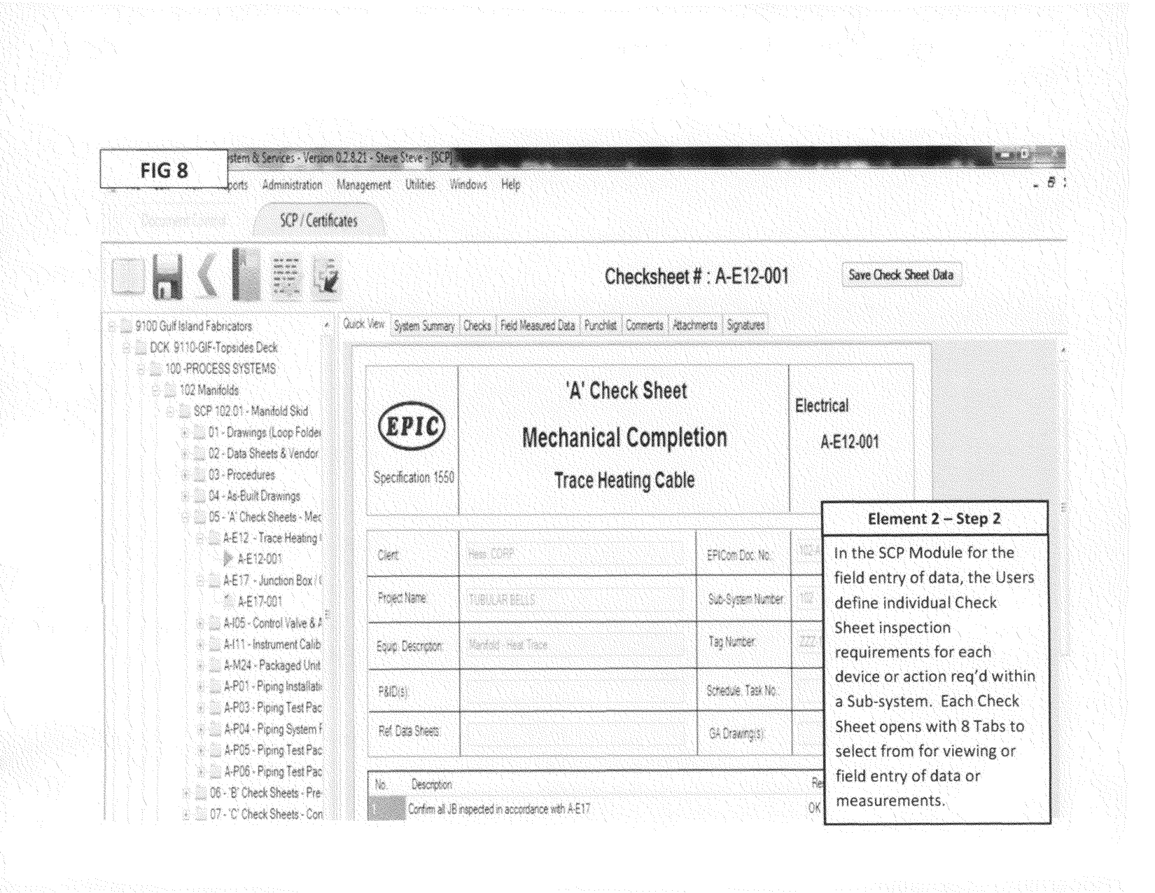

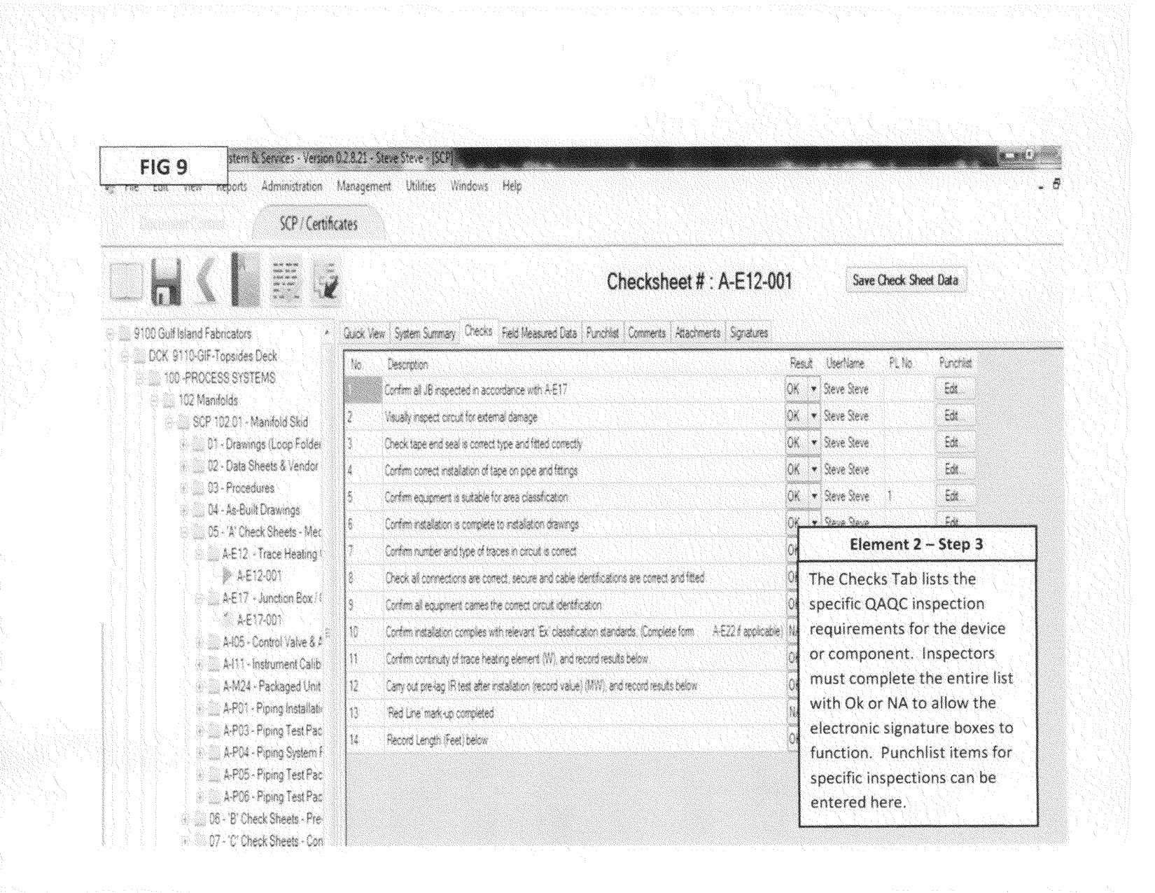

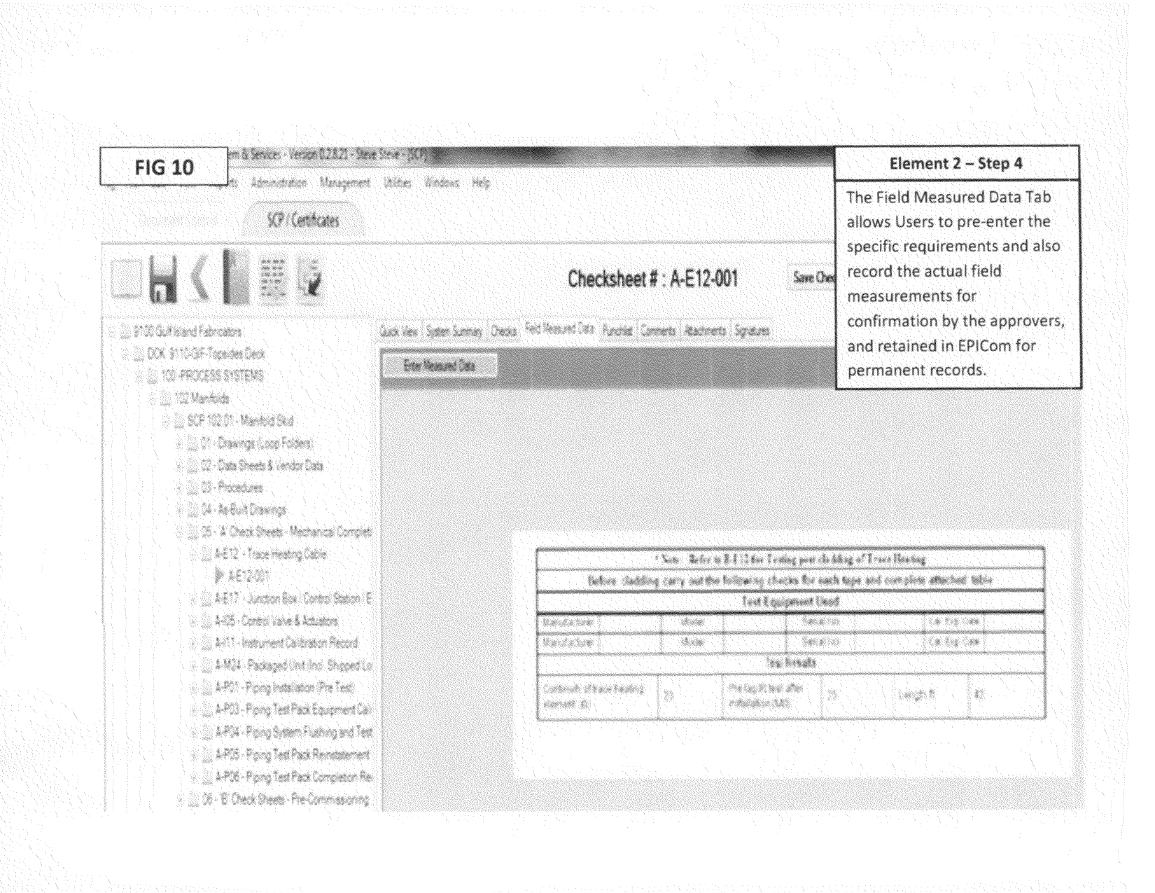

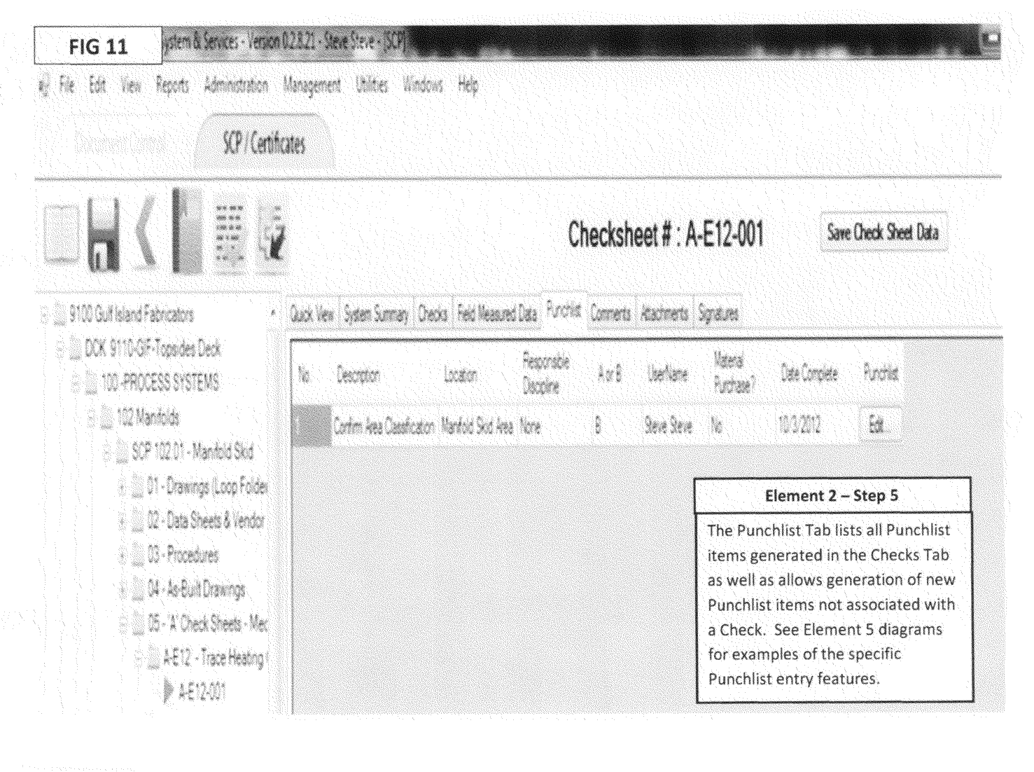

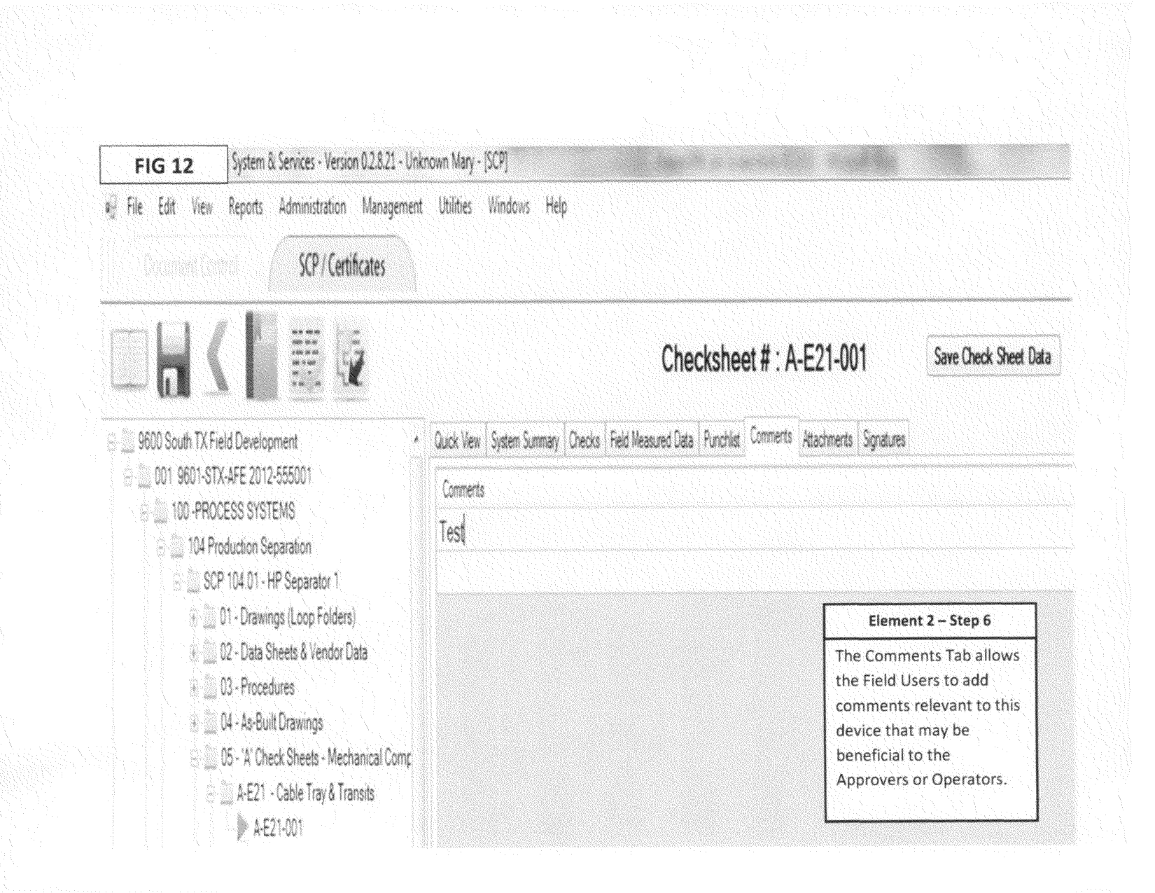

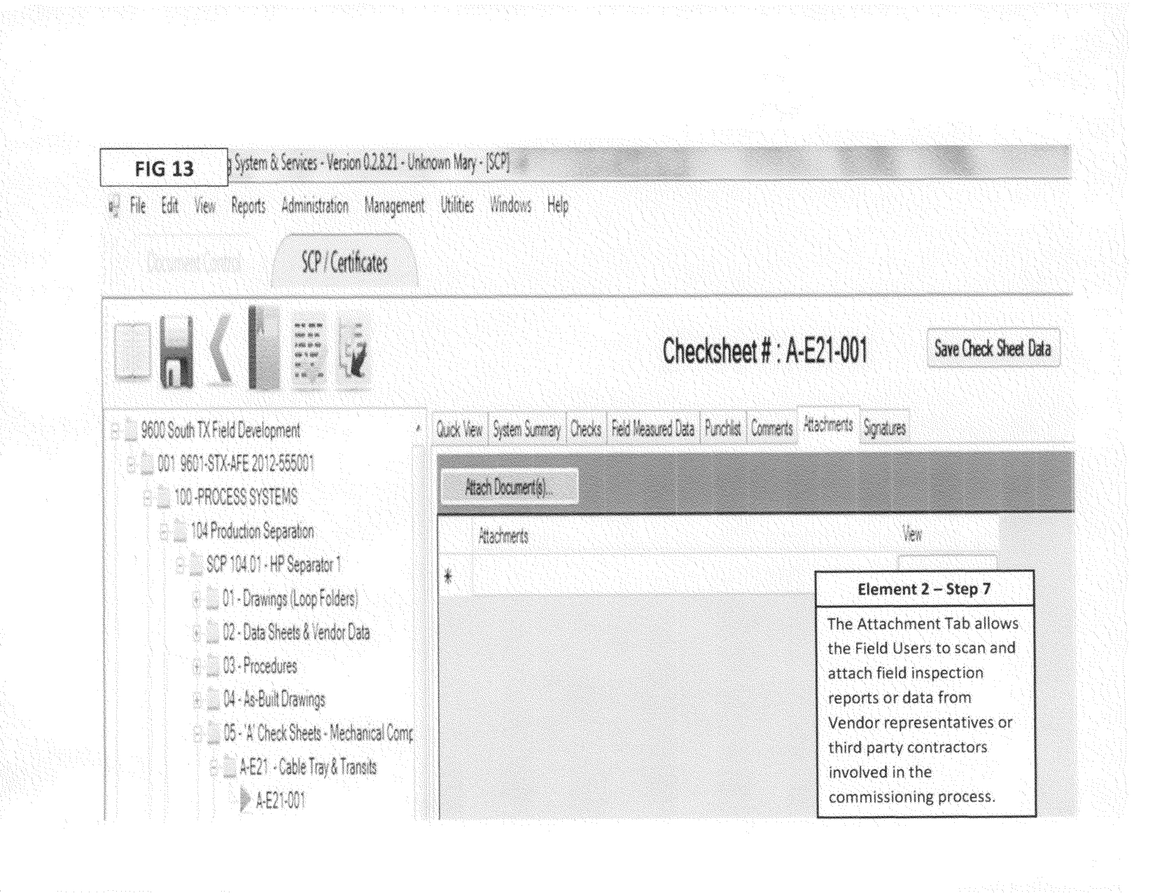

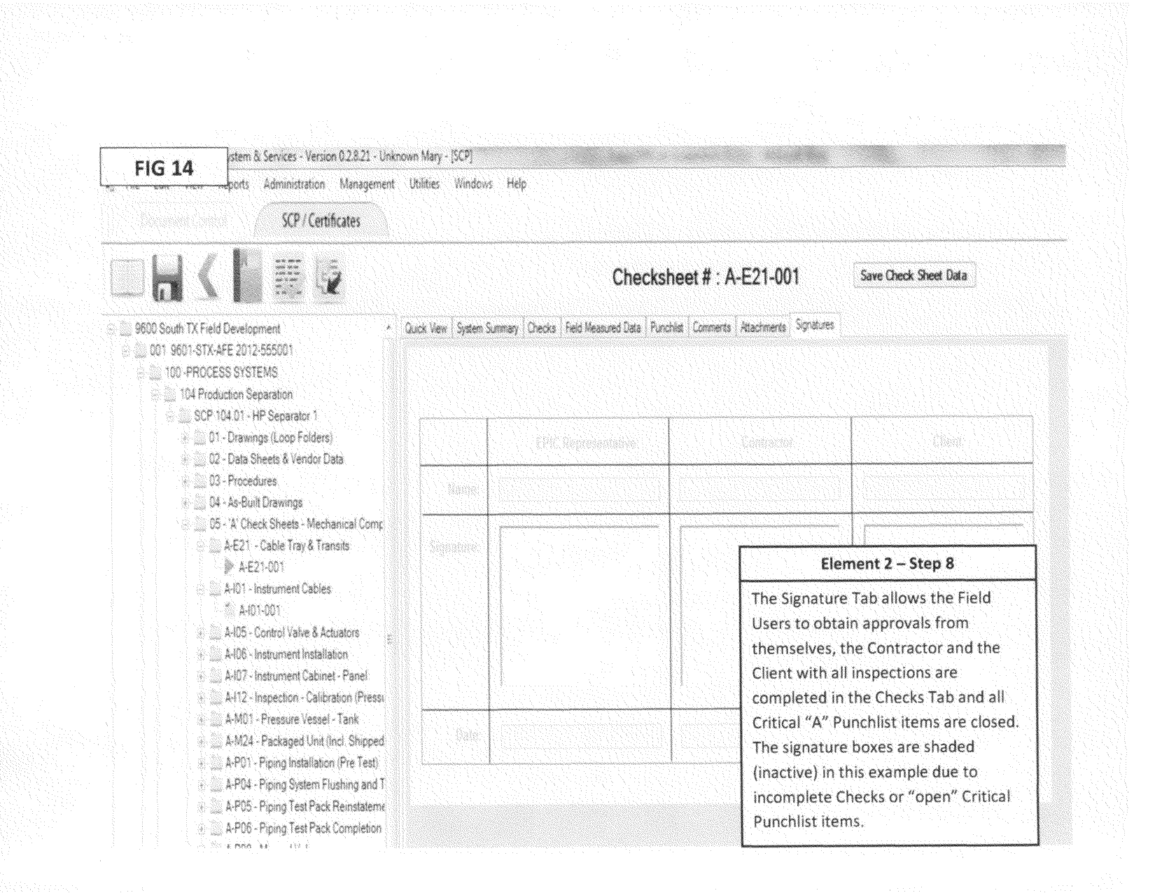

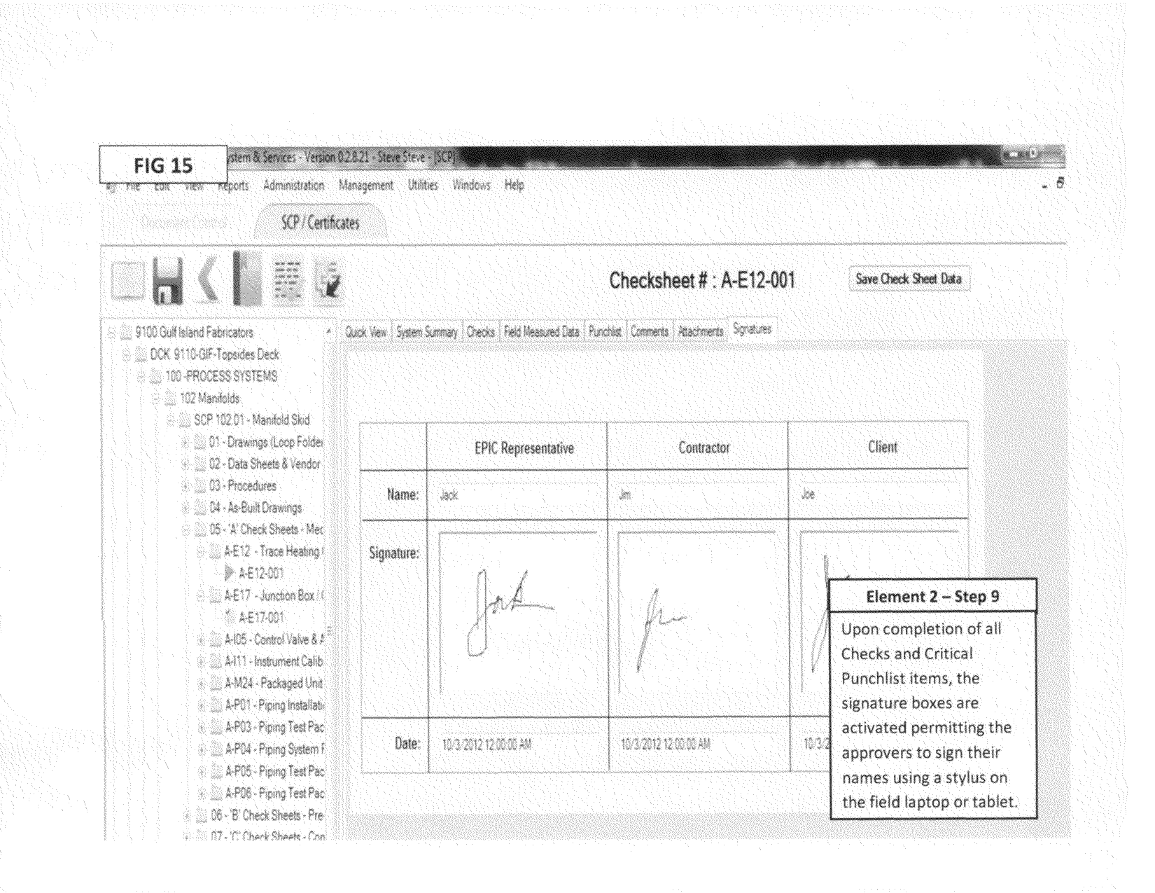

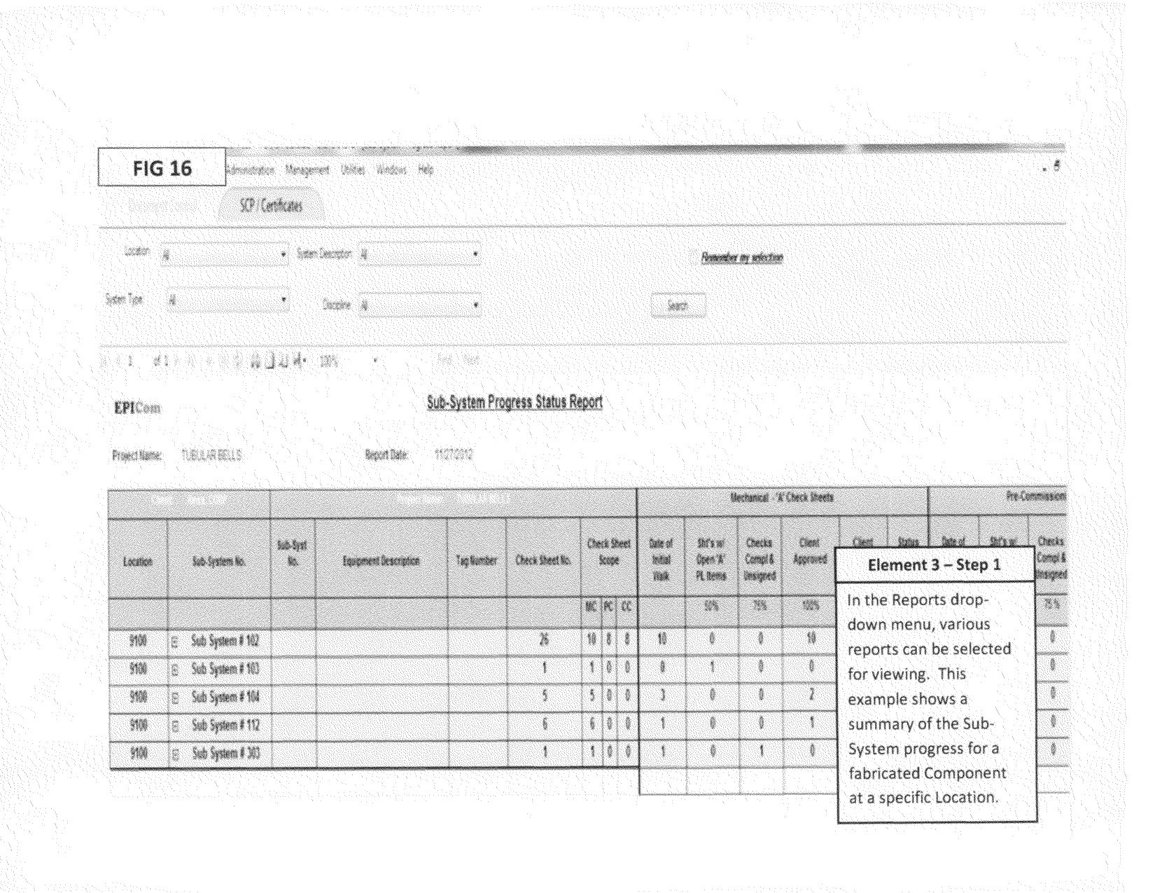

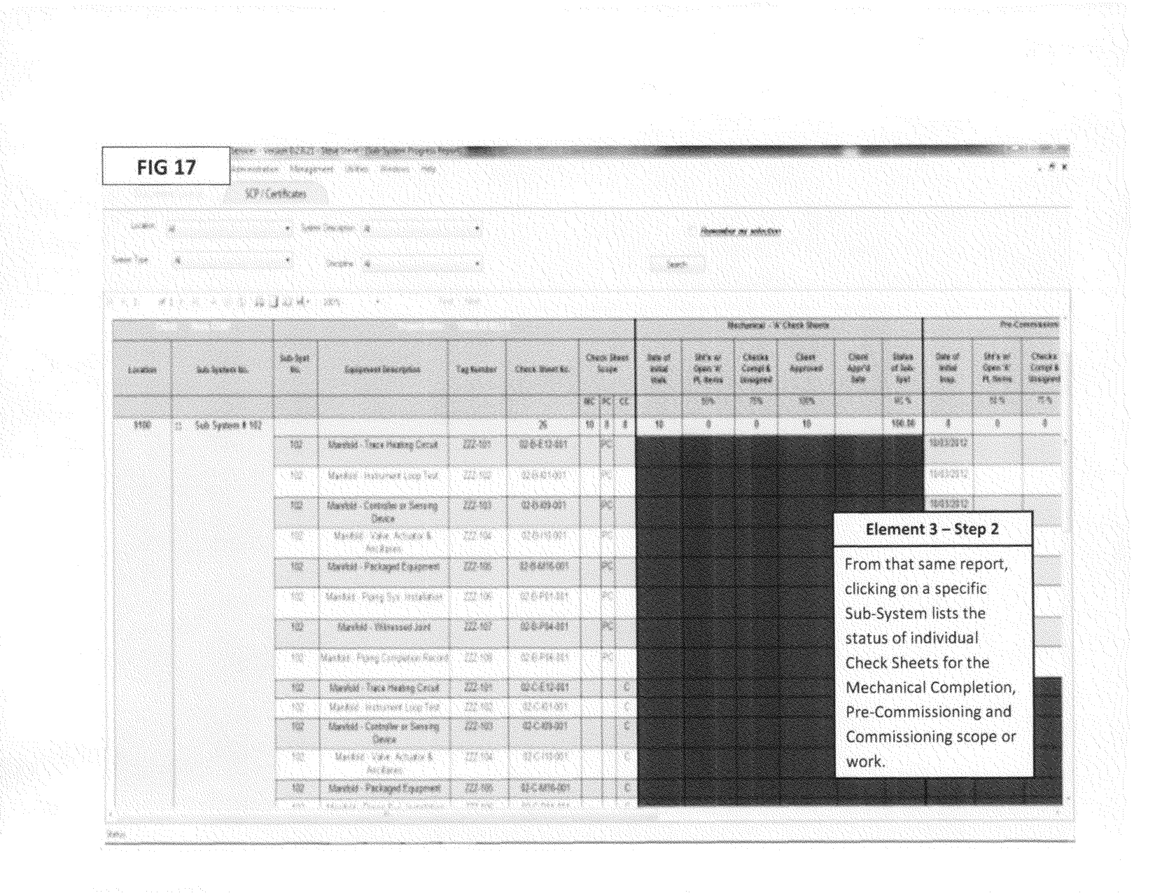

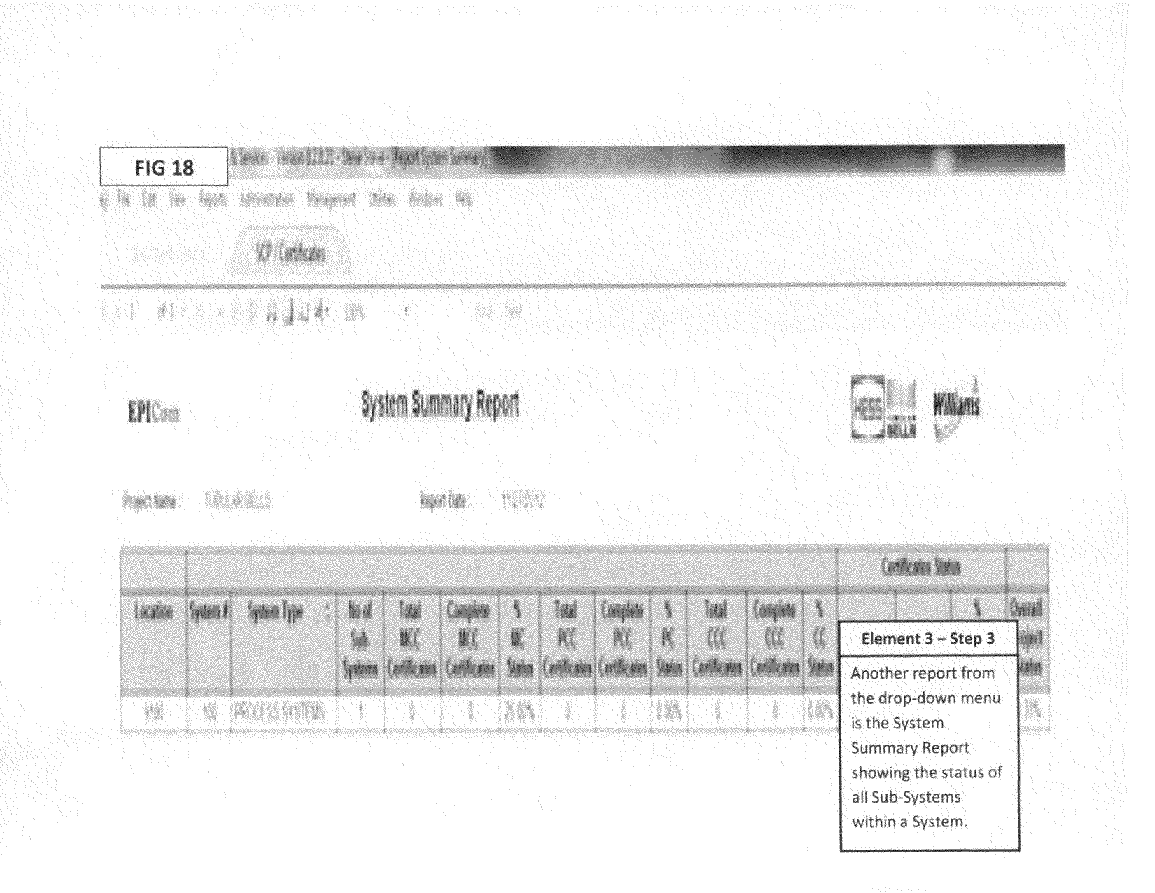

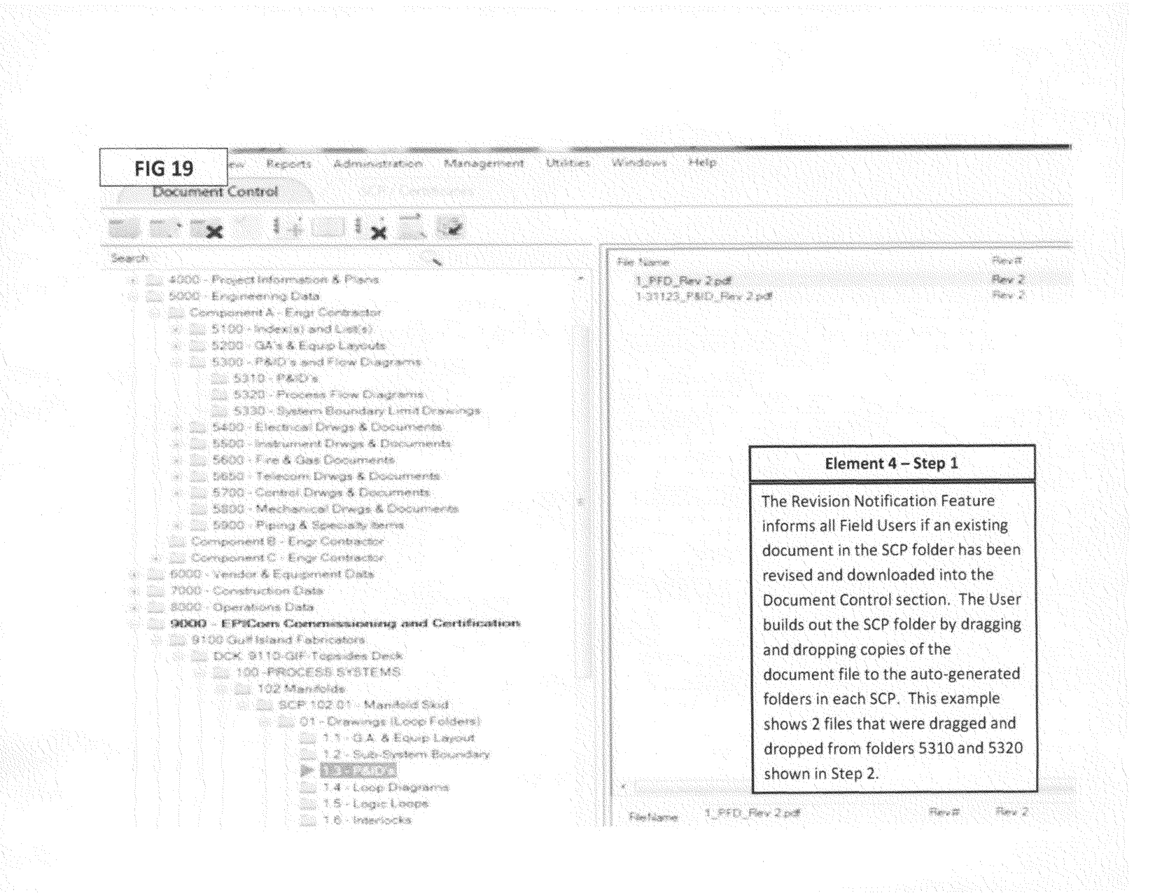

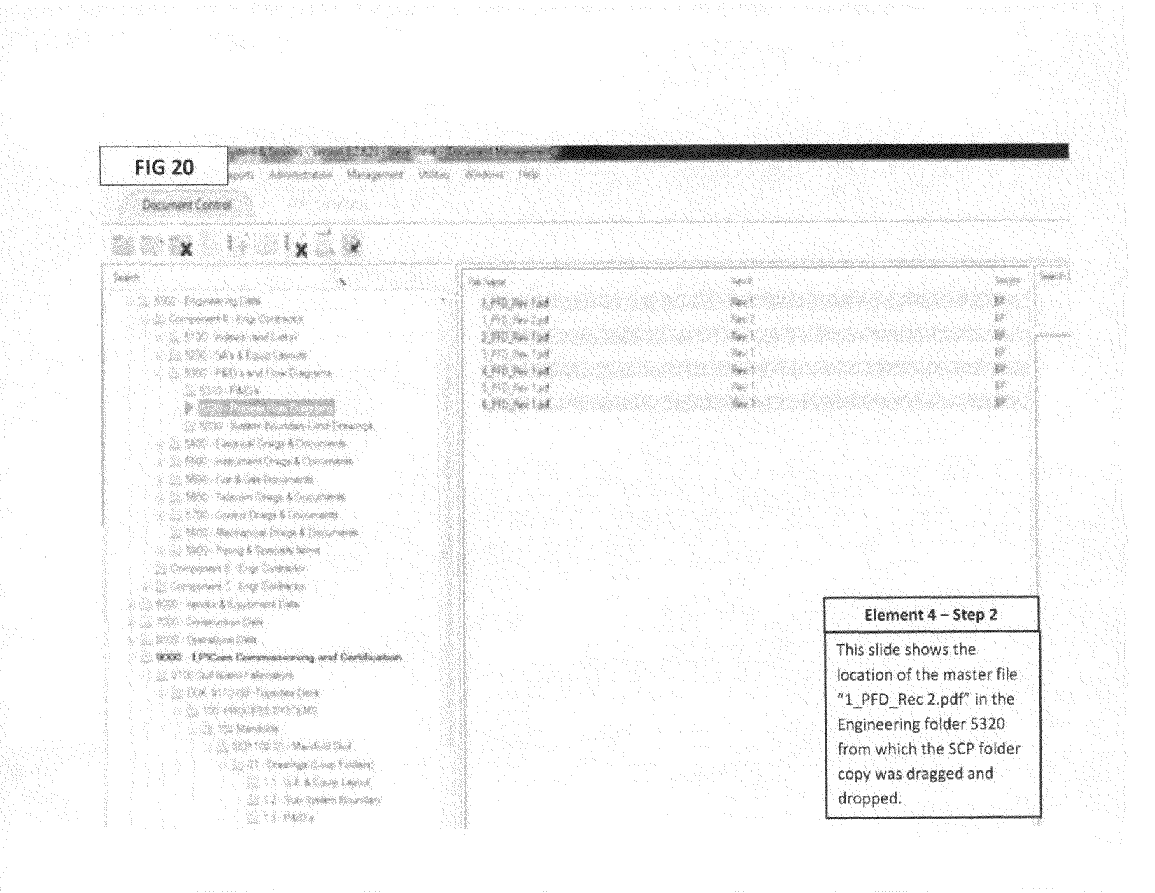

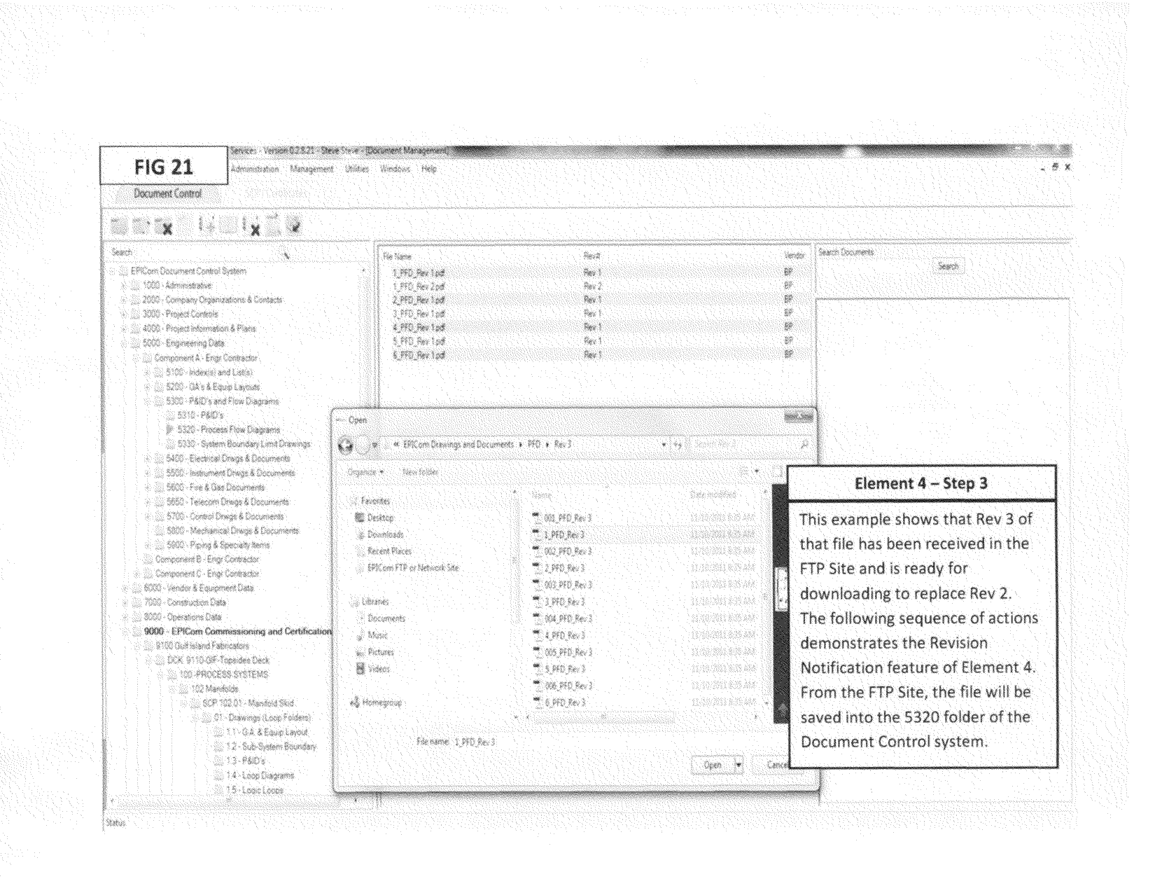

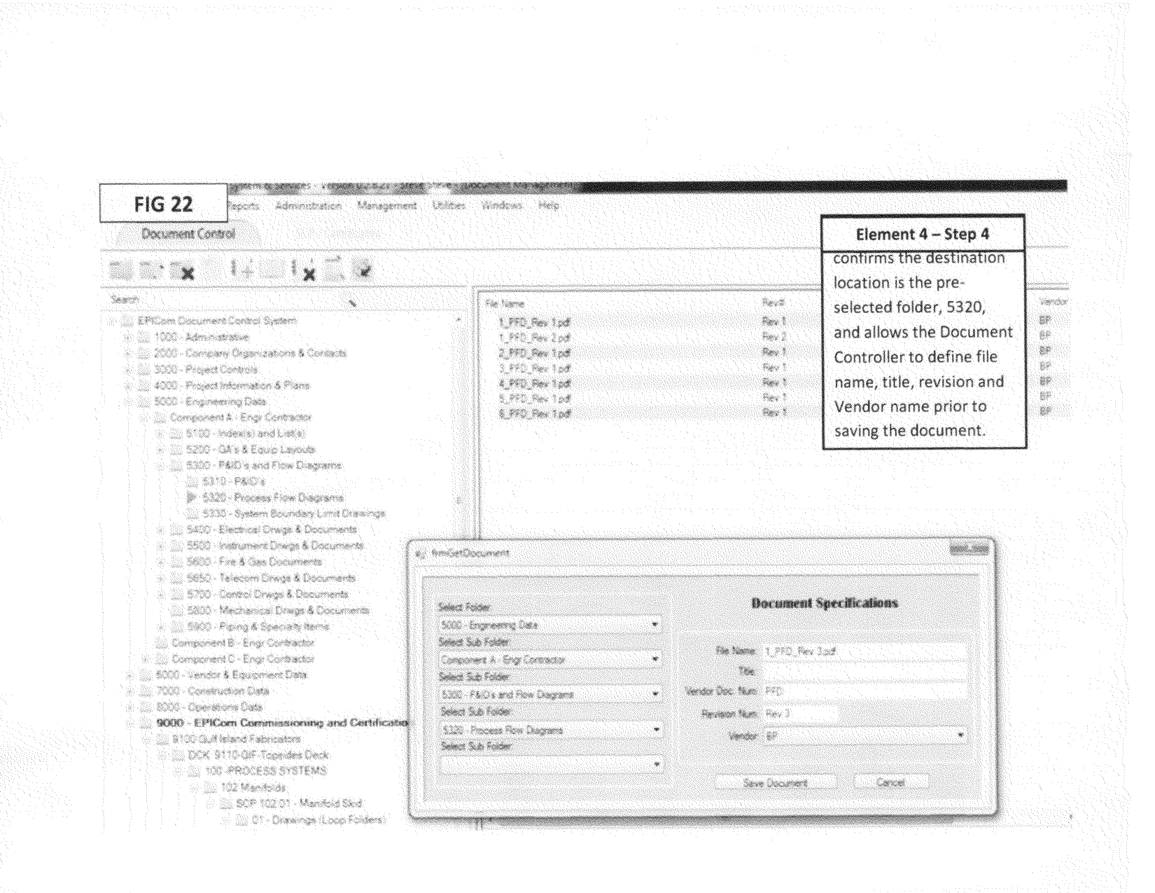

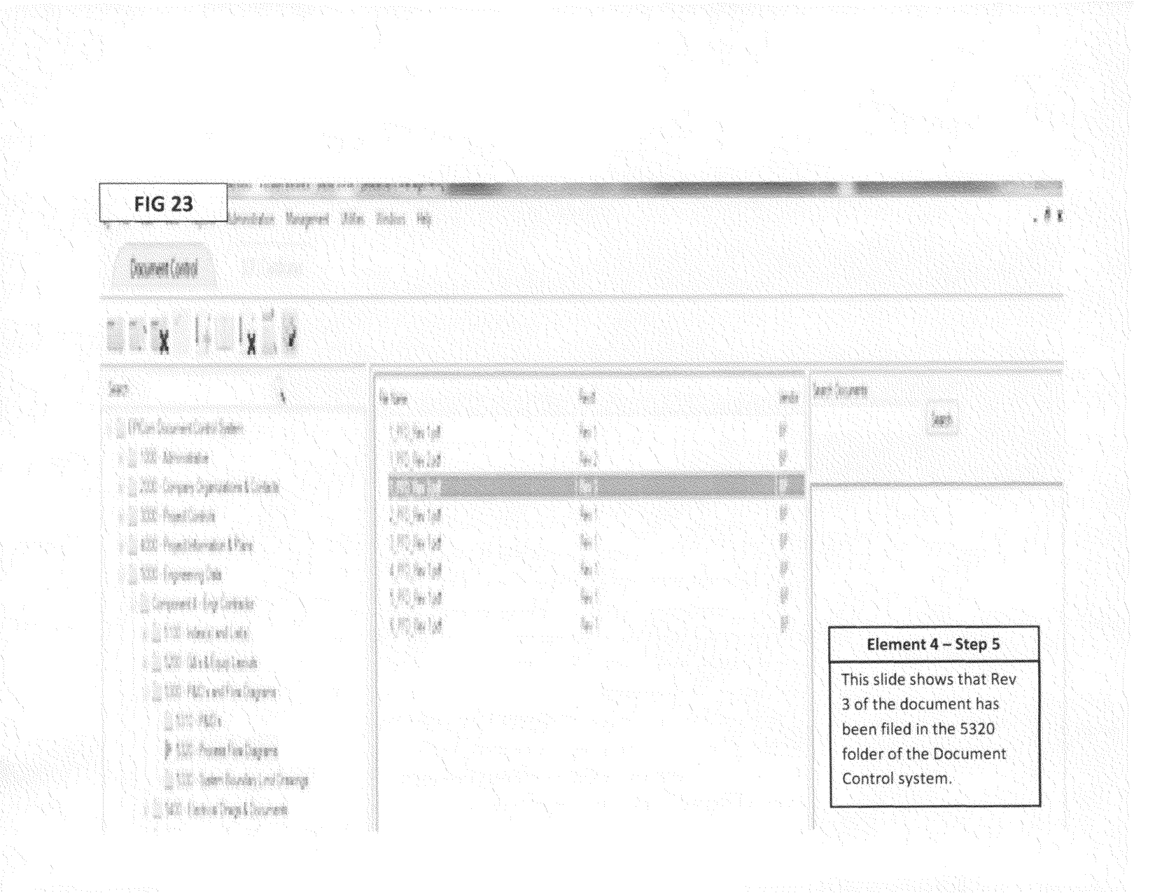

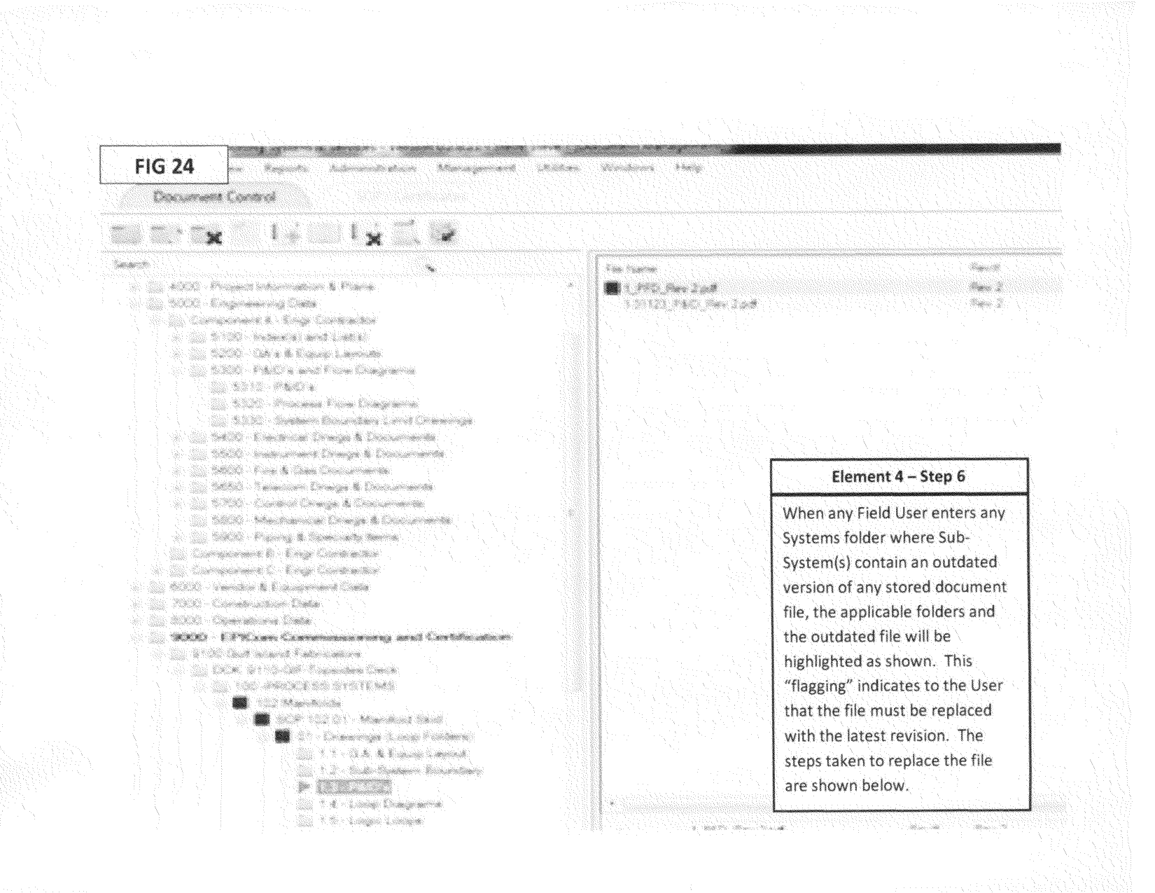

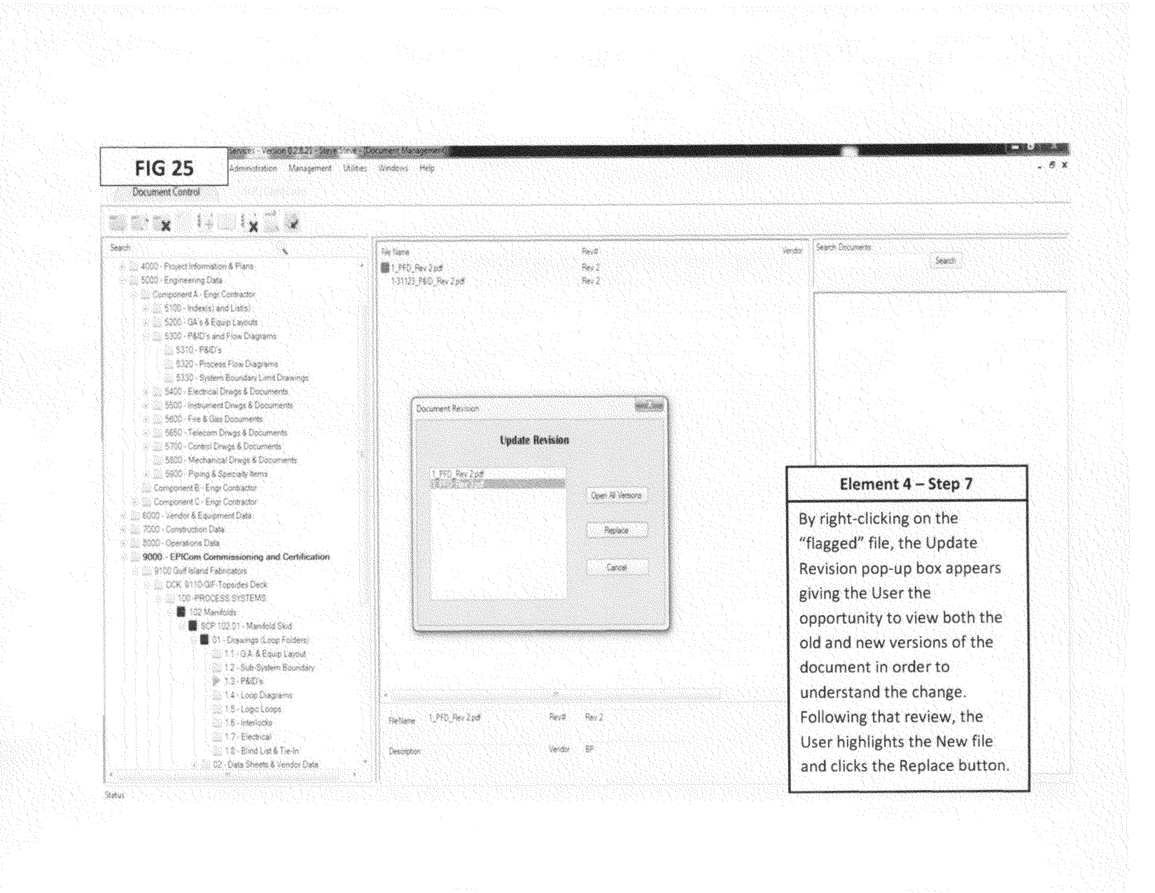

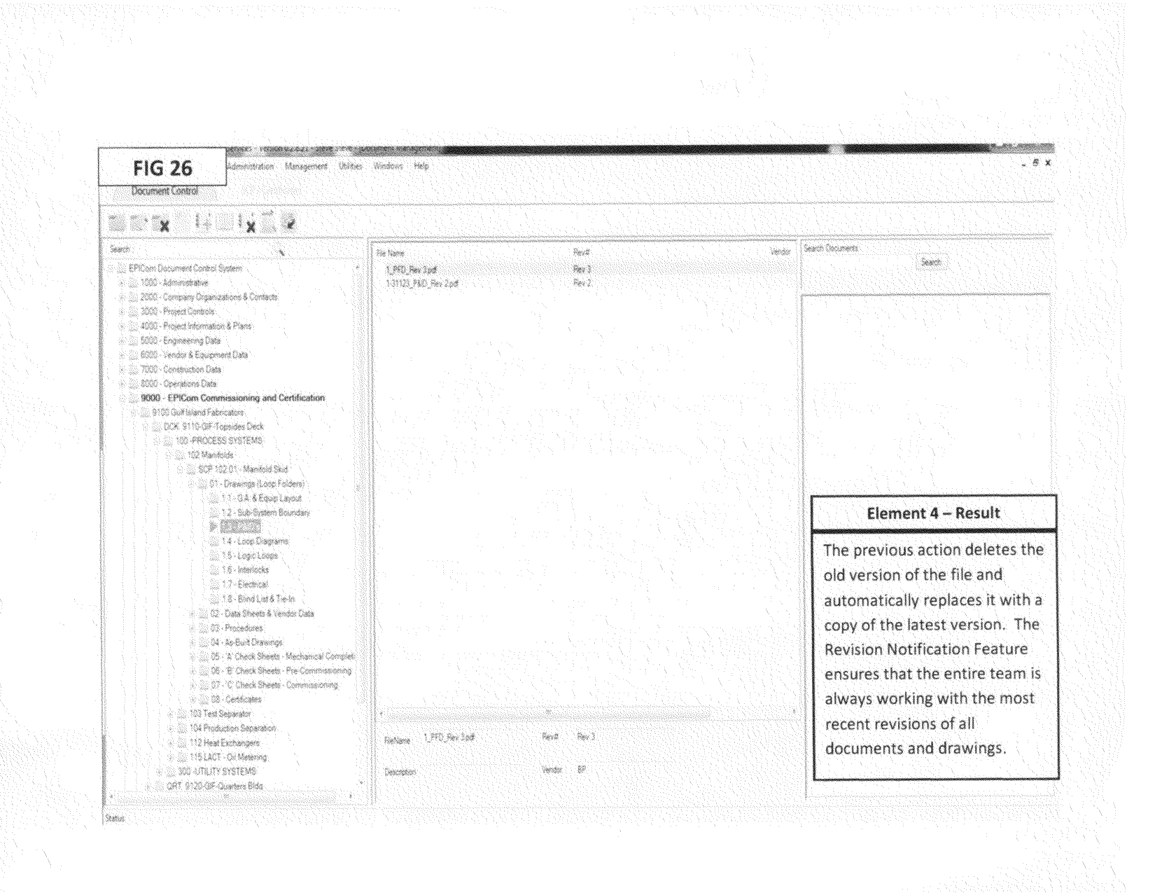

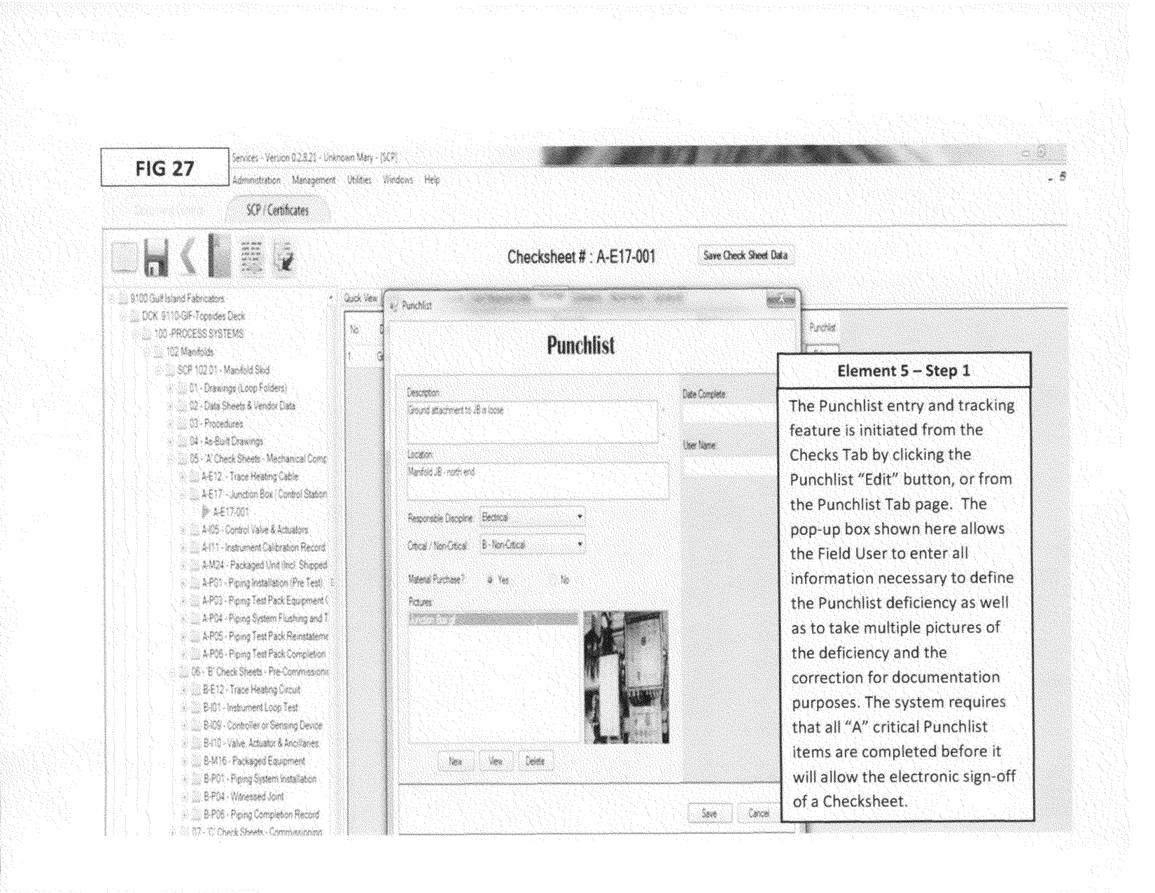

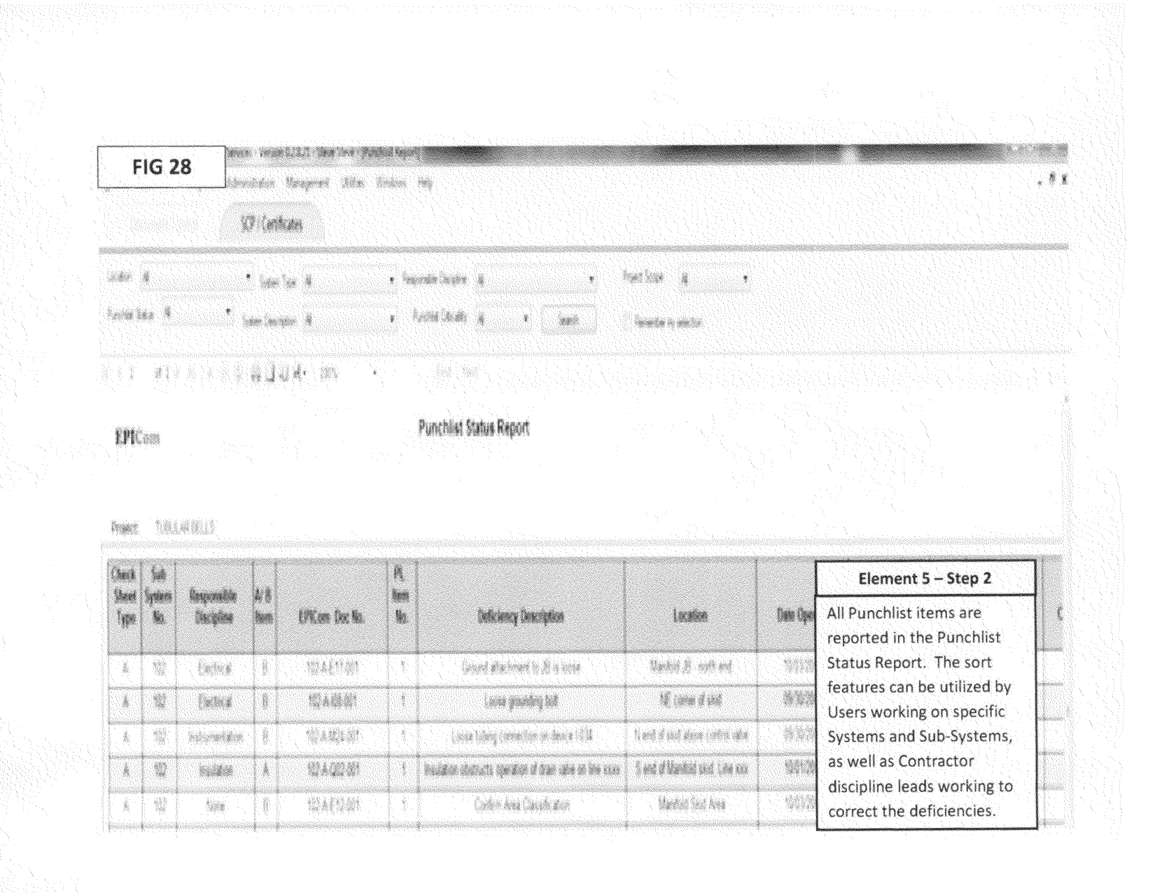

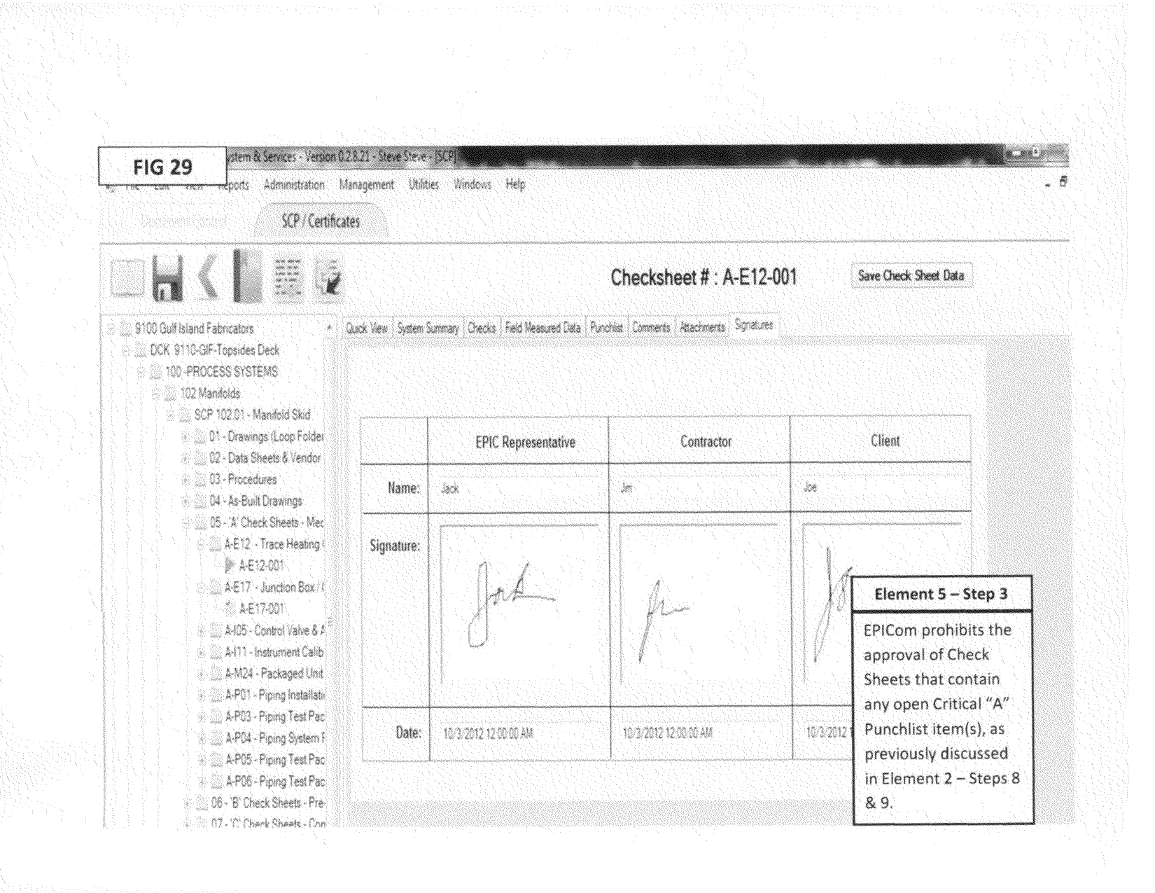

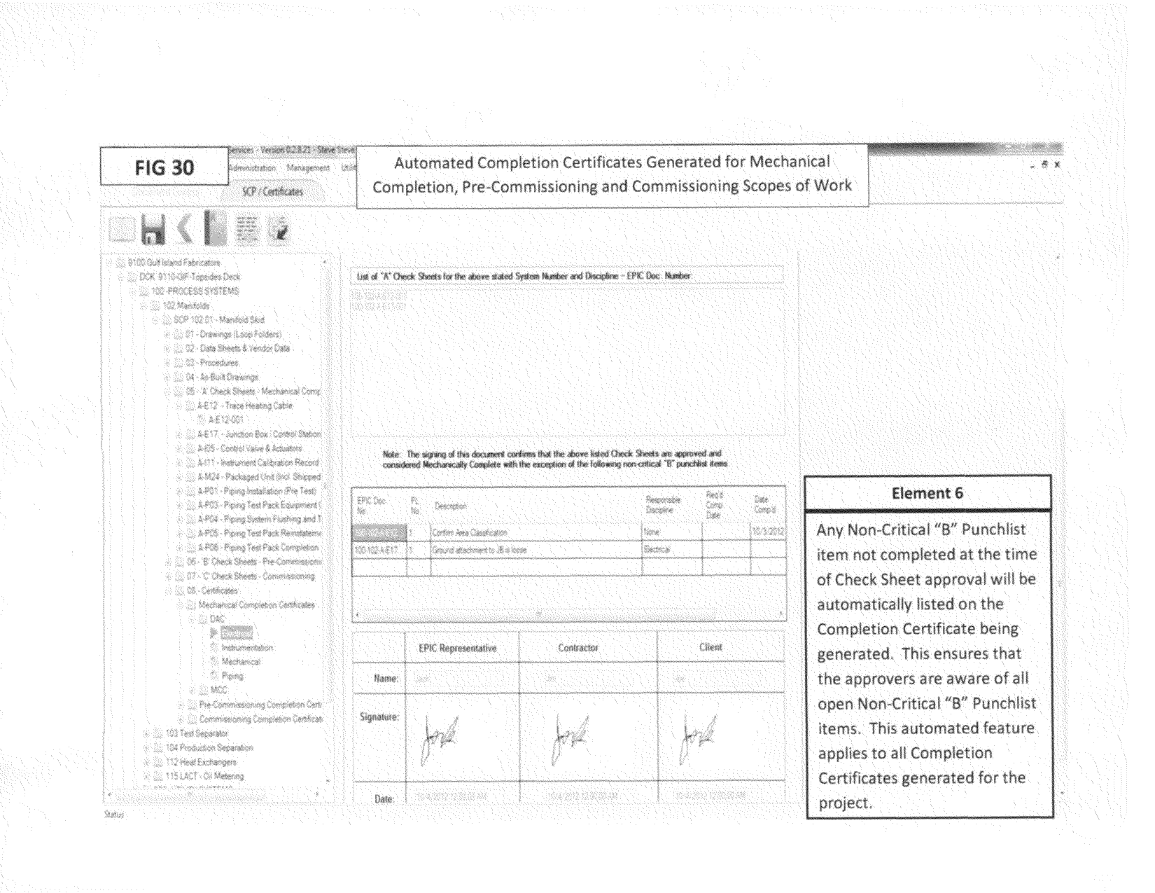

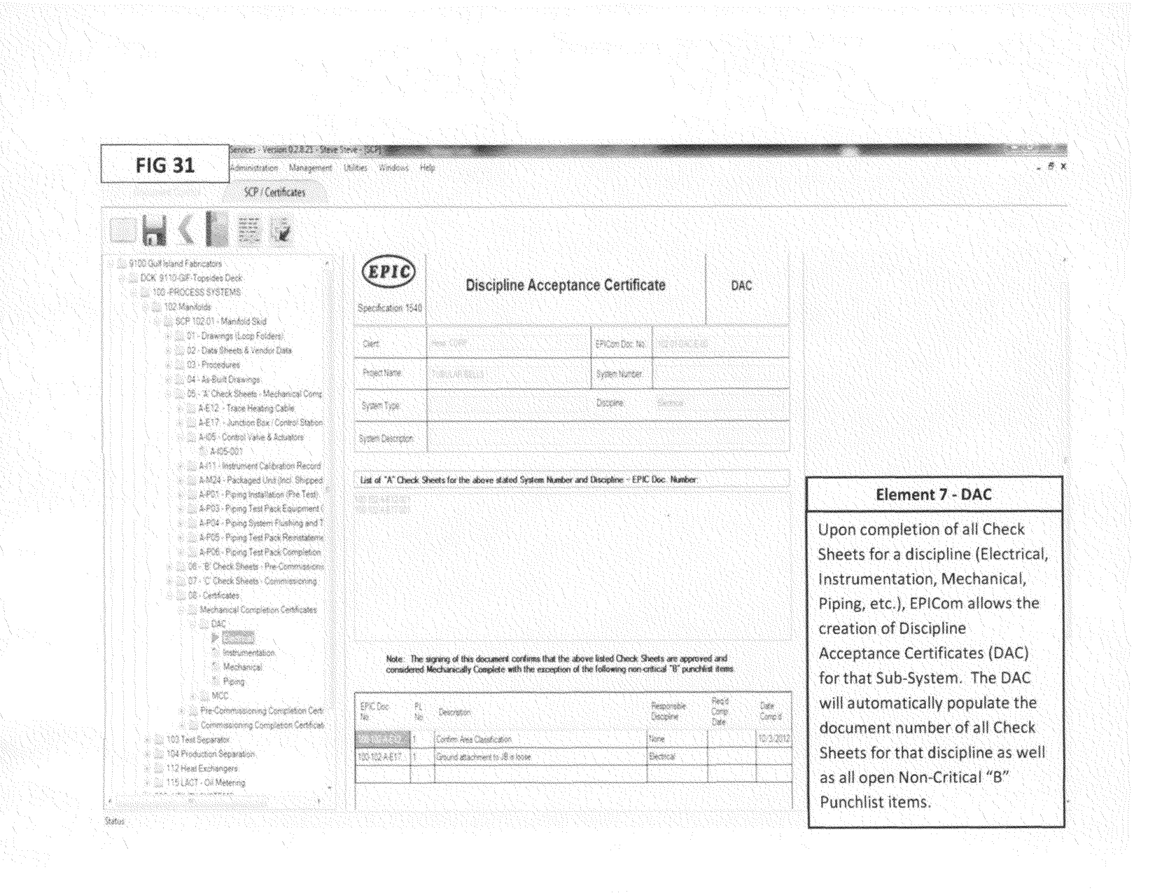

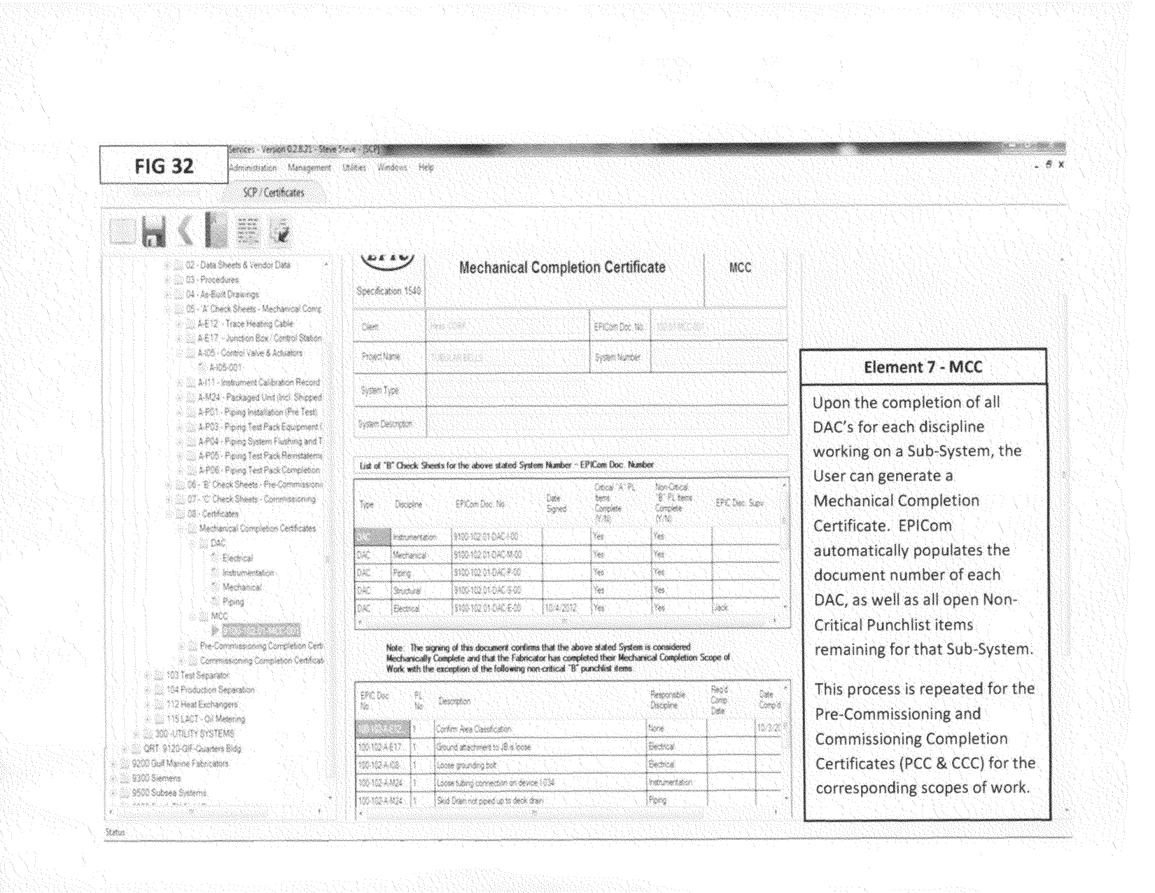

Commissioning team personnel, including Commissioning contractor, Client and facility fabrication contractor personnel, utilize the commissioning system software with desktop workstations and handheld mobile computers to efficiently record and report project status, Punchlist deficiencies and material procurement requirements. The Commissioning team personnel can utilize both field office workstations and handheld mobile computers to download the required documents from 3rd parties necessary to perform the scope of work activities and to perform the invention's seven (7) claimed elements, as shown in FIG. 1.

The invention can also be used by the Client to perform Preventive Maintenance and Predictive Maintenance activities following the commissioning and start-up of the oil and gas production facilities. All information recorded during the construction and commissioning scope of work, including all field measured data and equipment manufacturing data and test records, can be utilized by the Client to prepare and conduct the Preventive and Predictive Maintenance operations.

What is claimed is:

1. A method that comprises of allowing the automatic generation of each System Completion Package (SCP) document file structure for each of the Commissioning projects construction Locations, the Components being constructed at each Location, the Process and Utility Systems within each Component, and Sub-system for each piece of equipment within each System.

2. A method that comprises of allowing all field Users access to view documents in the document control system, as well as to a separate module that only allows pre-approved Users the ability to input field data in the Check Sheet inspection reports, record field measured data and QAQC inspections, record Punchlist deficiencies, record material procurement requirements, input comments, attach third party field reports and obtain Contractor and Client approvals in the field using electronic signature boxes. The invention prohibits inadvertent or preliminary approvals by disabling the electronic signature feature until all QAQC checks are complete on the Check Sheet and all Critical “A” Punchlist items are complete.

3. A method that comprises of allowing the automatic calculation of progress for each Sub-system, System, Component, Location, and overall Project progress based on the real-time status of each individual Check Sheet. The automatically generated Progress Reports are accessible by all Users.

4. A method that comprises of allowing site office Users, field and offsite Users automated and real-time notification of revised documents received and downloaded into the document control system.

5. A method that comprises of allowing the prevention of premature approval of inspection reports that contain Critical Punchlist deficiencies. All Punchlist deficiencies are entered into the automated Punchlist pop-up box and must be defined as Critical or Non-critical by the inspector. Critical Punchlist items must be completed and approved by the Client prior to the software allowing final signatures and approvals of the Check Sheets.

6. A method that comprises of allowing the automatic carry-over of the list of incomplete Non-critical Punchlist deficiencies to the next corresponding inspection report and Completion Certificate as the work progresses from Mechanical Completion, to Pre-Commissioning and finally to Commissioning activities.

7. A method that comprises of allowing the automatic generation of a Completion Certificate for the Mechanical Completion, Pre-Commissioning and Commissioning phases of work associated with the project for each of the various production and utility Sub-systems and Systems within all Components being fabricated at each of the project fabrication Locations. The Completion Certificates will be generated and auto-populate the Certificate form with document numbers of each inspection report utilized within a Sub-system and lists all Non-critical Punchlist deficiencies to be carried over to the next certification phase of the project. The invention prohibits the generation or approval of Completion Certificates if any inspection report is incomplete or not approved.
